(19) United States
(12) Patent Application Publication
(10) Pub. No.: US 2014/0050001 A1
(43) Pub. Date: Feb. 20, 2014

(54) REACTOR, COMPOSITE MATERIAL, REACTOR CORE, CONVERTER, AND POWER CONVERSION DEVICE

(71) Applicant: Kazuhiro Inaba, Osaka-shi (JP)

(72) Inventor: Kazuhiro Inaba, Osaka-shi (JP)

(73) Assignee: Sumitomo Electric Industries, Ltd., Osaka-shi (JP)

(21) Appl. No.: 14/114,480

(22) PCT Filed: Apr. 20, 2012
(86) PCT No.: PCT/JP2012/060693

§ 371 Date: Oct. 28, 2013

(30) Foreign Application Priority Data
Apr. 28, 2011 (JP) 2011-100554
Mar. 2, 2012 (JP) 2012-047082

(51) Int. Cl. H01F 27/255; H02M 7/537

(52) U.S. Cl. CPC H01F 27/255; H02M 7/537
USPC 363/131; 323/351; 336/221; 336/233; 252/62.54

(57) ABSTRACT

A reactor 1A includes a single coil 2 formed by spirally winding a wire 2w and a magnetic core 3 that is disposed inside and outside the coil 2 and forms a closed magnetic circuit. The magnetic core 3 includes an inner core portion 31 disposed inside the coil 2 and an outer core portion 32 disposed so as to cover the outer periphery of the coil 2. The outer core portion 32 is formed of a composite material containing a magnetic powder and a resin. In a section of this composite material, the maximum bubble diameter is 300 μm or less. In the reactor 1A, the outer core portion 32 has a maximum bubble diameter of 300 μm or less and, as a result, the loss is low and magnetic characteristics are less likely to be decreased.

### TECHNICAL FIELD

The present invention relates to a composite material that is suitable as a material for forming magnetic components such as reactors; a reactor core formed of this composite material; a reactor including this core; a converter including this reactor; and a power conversion device including this converter. In particular, the present invention relates to a reactor in which the loss is low and magnetic characteristics are less likely to be decreased; and a composite material that provides a reactor in which the loss is low and magnetic characteristics are less likely to be decreased.

### BACKGROUND ART

Magnetic components including a coil and a magnetic core, such as reactors and motors, are used in various fields. For example, Patent Literature 1 discloses a reactor that is used as a circuit component of a converter incorporated in a vehicle such as a hybrid electric vehicle. Patent Literature 1 also discloses, as a material for forming the magnetic core of such a reactor, a composite material formed of a magnetic powder and a resin (binder resin) that contains this powder. This composite material can be produced by charging a raw-material mixture of a magnetic powder and an uncured liquid resin into a mold having a desired shape, and by subsequently curing the resin.

### CITATION LIST

### Patent Literature

PTL 1: Japanese Unexamined Patent Application Publication No. 2008-147403

### SUMMARY OF INVENTION

### Technical Problem

In some reactors having a magnetic core formed of an existing composite material, the loss such as iron loss becomes high or magnetic characteristics such as a relative magnetic permeability and an inductance become less than the set values. Examination of the existing composite material has revealed the presence of large bubbles having a size of more than 300 μm.

When the above-described large bubbles are present in a composite material containing a magnetic powder and a resin, since the bubbles have a lower relative magnetic permeability than the magnetic powder, the magnetic flux generated by the coil largely circumvents the large bubbles. When this circumvention of magnetic flux causes local variations in the distribution of lines of magnetic induction in the composite material, the relative magnetic permeability of the composite material may be decreased on the whole. The decrease in the relative magnetic permeability may lead to an inductance value that is less than the set value. The circumvention of magnetic flux may also cause an increase in the loss. In addition, large bubbles may also cause a decrease in the thermal conductivity of the composite material and lack of sufficient heat dissipation from the coil may cause an increase in the loss. Accordingly, the presence of the above-described large bubbles is probably a cause of an increase in the loss and a decrease in magnetic characteristics in the reactor. The correlation between the loss and magnetic characteristics of a reactor including a composite material and the size of bubbles in the composite material and the correlation between the thermal conductivity of the composite material and the size of bubbles in the composite material have not been considered. These correlations have been firstly focused on by the inventor of the present invention.

Accordingly, an object of the present invention is to provide a reactor in which the loss is low and magnetic characteristics are less likely to be decreased. Another object of the present invention is to provide a reactor core that provides a reactor in which the loss is low and magnetic characteristics are less likely to be decreased. Furthermore, another object of the present invention is to provide a composite material that is suitable as a material for the above-described reactor core or a material for the magnetic core of the above-described reactor.

### Solution to Problem

The inventor of the present invention has found that, in the production step of a composite material containing a magnetic powder and a resin, a degassing step for sufficiently discharging bubbles (gas) from the composite material is deliberately performed to thereby provide a composite material having a maximum bubble diameter of 300 μm or less. The inventor has also found that, when a composite material having a maximum bubble diameter of 300 μm or less is used as a material of a magnetic core, in a reactor including this magnetic core, magnetic characteristics are less likely to be decreased from the set values and the loss is low. The present invention is based on the above-described findings.

A composite material according to the present invention is a composite material including a magnetic powder and a resin, wherein the maximum diameter of bubbles in a section of the composite material is 300 μm or less.

The above-described composite material according to the present invention can be produced by, for example, a production method described below. In particular, this production method can be suitably used when the resin is a thermosetting resin or a thermoplastic resin. This production method relates to a method in which a magnetic powder and an uncured resin are mixed and this resin is subsequently cured to produce the composite material. The production method includes the following mixing step, charging step, degassing step, and curing step.

Mixing step: a step in which a magnetic powder and a resin are stirred under degassing to prepare a fluid mixture.

Charging step: a step in which the temperature at which the fluid mixture exhibits the minimum viscosity is defined as Tmin (° C.), temperatures selected from the range of (Tmin−20)° C. or more to (Tmin−5)° C. or less are defined as T₁ (° C.) and T₂ (° C.), and the fluid mixture being heated at the temperature T₁ (° C.) is charged into a mold being heated at the temperature T₂ (° C.).

Degassing step: a step in which the fluid mixture having been charged into the mold is held at a temperature of (Tmin±5)° C. for a predetermined time while degassing is performed such that the ultimate degree of vacuum becomes 1 Pa or less.

Curing step: a step in which, after the predetermined time elapses, the resin is cured.

A reactor core according to the present invention includes the above-described composite material according to the present invention. A reactor according to the present invention includes a coil and a magnetic core, wherein at least a portion of the magnetic core is formed of the above-described composite material according to the present invention. That is, in a reactor according to the present invention, at least a portion of the magnetic core is formed of a composite material containing a magnetic powder and a resin, and bubbles in a section of the composite material have a maximum diameter of 300 μm or less.

In a composite material according to the present invention, a reactor core according to the present invention including this composite material, and a composite material forming at least a portion of a magnetic core in a reactor according to the present invention, even when bubbles are present, the maximum diameter of the bubbles is 300 μm or less and hence variations in the distribution of magnetic flux due to the presence of the bubbles can be suppressed. Accordingly, for example, in view of the inductance value, the difference between the design value and the actual value is small and a decrease from the design value can be sufficiently suppressed. By using such a composite material according to the present invention or a reactor core according to the present invention, a reactor in which the loss is low and magnetic characteristics are less likely to be decreased can be produced. A reactor according to the present invention includes the above-described specific composite material, which is the above-described composite material according to the present invention, or a reactor core according to the present invention and, as a result, the loss is low and magnetic characteristics are less likely to be decreased.

Furthermore, in a configuration in which the maximum diameter of bubbles in a section of the composite material is 200 μm or less, even when bubbles are present, the bubbles are smaller. Accordingly, by using a composite material according to this configuration, a reactor can be obtained in which the loss is lower and magnetic characteristics are even less likely to be decreased. In addition, in a reactor including this composite material, the loss is lower and magnetic characteristics are even less likely to be decreased.

In the above-described production method, firstly, by performing degassing (typically, vacuuming) during mixing and stirring of the magnetic powder and the resin, discharge of bubbles from the fluid mixture is facilitated and gas in the atmosphere is less likely to be introduced into the fluid mixture. Thus, the resultant fluid mixture has a low bubble content. Secondly, in charging of this fluid mixture into a mold, both of the fluid mixture and the mold are heated at the temperatures T₁ (° C.) and T₂ (° C.) that are selected from the specific range. As a result, the fluid mixture exhibits a low viscosity. Thus, the fluid mixture has high flowability and is easily charged into the mold; in addition, due to the high flowability, bubbles in the fluid mixture tend to be discharged to the outside. In addition, since both of the fluid mixture and the mold are at similar temperatures, after the fluid mixture is sequentially charged into the mold, the temperature of the fluid mixture in spite of being in contact with the mold is less likely to be decreased and is substantially kept at a constant temperature. Thus, the fluid mixture can be maintained in the state of exhibiting a low viscosity and hence bubbles tend to be discharged. After the fluid mixture is charged into the mold, the fluid mixture is held at and around the temperature Tmin (° C.) at which the resin exhibits the minimum viscosity so that the resin is kept in the state of exhibiting a low viscosity. Accordingly, bubbles tend to be discharged from the fluid mixture in the mold; in addition, the gas having been discharged from the fluid mixture can be discharged to the outside with certainty by vacuuming to the above-described predetermined degree of vacuum. Thus, the resultant fluid mixture is sufficiently degassed. The resin in this fluid mixture is cured and the resultant composite material has a maximum bubble diameter of 300 μm or less.

As described above, not only performing degassing during mixing and charging, but also separately performing the specific degassing step, a composite material having a maximum bubble diameter of 300 μm or less according to the present invention can be produced.

A reactor according to the present invention and a composite material according to the present invention may have a configuration in which the total area percentage of the bubbles in the section of the composite material is 1% or less.

In this configuration, the maximum diameter of bubbles is 300 μm or less and the total content of the bubbles itself is also low. Accordingly, by using the composite material having the configuration, a reactor can be obtained in which the loss is lower and magnetic characteristics are even less likely to be decreased. In the reactor having the configuration, the loss is lower and magnetic characteristics are even less likely to be decreased.

A reactor according to the present invention and a composite material according to the present invention may have a configuration in which the total area percentage of the bubbles in the section of the composite material is 0.2% or less.

In this configuration, the maximum diameter of bubbles is 300 μm or less and the total content of the bubbles itself is also very low. Accordingly, by using the composite material having the configuration, a reactor can be obtained in which the loss is even lower and magnetic characteristics are even less likely to be decreased. In the reactor having the configuration, the loss is even lower and magnetic characteristics are even less likely to be decreased.

A reactor according to the present invention and a composite material according to the present invention may have a configuration in which the volume percentage of the magnetic powder in the composite material is 30% by volume or more and 70% by volume or less.

In this configuration, the percentage of the magnetic component is sufficiently high and hence magnetic characteristics such as a saturation flux density are easily increased; in addition, the content of the magnetic powder is not excessively high and hence mixing of the magnetic powder with the resin is facilitated and the composite material is easily produced.

A reactor according to the present invention may have a configuration in which at least a portion of a part of the magnetic core, the part being disposed inside the coil that has a cylindrical shape and is formed by winding a wire, is formed of the composite material.

A magnetic core in a reactor according to the present invention may include different materials depending on portions.

In the above-described configuration in which at least a portion of a part of the magnetic core, the part being disposed inside the coil, is formed of the above-described composite material, for example, when a part of the magnetic core, the part being disposed outside the coil, is formed of a material having a higher relative magnetic permeability than the composite material, flux leakage from the part disposed outside the coil to the outside can be reduced. Accordingly, loss due to this flux leakage can be reduced and the magnetic flux generated by the coil can be sufficiently used.

A reactor according to the present invention may have a configuration in which at least a portion of a part of the magnetic core, the part being disposed outside the coil that has a cylindrical shape and is formed by winding a wire, is formed of the composite material.

In the above-described configuration in which at least a portion of a part of the magnetic core, the part (hereafter, referred to as an outer core) being disposed outside the coil, is formed of the above-described composite material, for example, a part of the magnetic core, the part (hereafter, referred to as an inner core) being disposed inside the coil, may be formed of a material having a higher saturation flux density than the composite material. In this configuration, in view of obtaining a certain magnetic flux, compared with the case where the magnetic core is entirely formed of a material having a low relative magnetic permeability and has a uniform saturation flux density, the sectional area of the inner core can be decreased. Accordingly, in the above-described configuration, reduction of the size of the reactor can be achieved. In addition, as a result of the reduction of the size of the inner core, the length of the wire forming the coil can also be decreased. Accordingly, in the above-described configuration, the weight of the reactor can be decreased.

A reactor according to the present invention may have a configuration in which the magnetic core is substantially entirely formed of the composite material.

In this configuration, the resin component is contained and hence the magnetic core is entirely formed of a material having a relatively low relative magnetic permeability. Accordingly, for example, a gapless structure can be provided. In the configuration, when the magnetic core is entirely formed of a single material, high productivity is achieved. Alternatively, in the configuration, for example, by adjusting the material or the content of the magnetic powder, a magnetic core having different magnetic characteristics depending on portions can be easily produced.

A reactor according to the present invention may have a configuration further including a case that houses an assembly of the coil and the magnetic core. In this case, a configuration may be employed in which the coil is housed in the case such that an axis of the coil is substantially parallel to a bottom surface of the case; and a part of the magnetic core, the part covering at least a portion of an outer periphery of the coil, is formed of the composite material.

In this configuration, the coil is housed in the case such that the outer peripheral surface of the coil faces the bottom surface of the case. Accordingly, the distance between the outer peripheral surface of the coil and the bottom surface of the case tends to be short. Thus, in the configuration, the heat of the coil tends to be conducted to the bottom surface of the case and can be dissipated through this bottom surface to a mount base for the reactor. Accordingly, high heat-dissipation capability is provided. In addition, in the above-described configuration, the assembly of the coil and the magnetic core is housed in the case so that the assembly can be mechanically protected and protected from the external environment. The reactor having the above-described configuration can be produced by, for example, the above-described production method in which the case is used as the mold, the coil or the assembly of the coil and a part of the magnetic core is housed in this case, and the composite material is formed in accordance with the above-described production method. This composite material constitutes at least a portion of the magnetic core of the reactor. When the case is used as the mold, the above-described configurations can be easily produced: the configuration in which at least a portion of a part of the magnetic core, the part being disposed outside the coil, is formed of the composite material; and the configuration in which the magnetic core is substantially entirely formed of the composite material.

In a reactor having such a configuration, in order to adjust the inductance of the reactor to a predetermined value, a composite material according to the present invention constituting the magnetic core preferably has a relative magnetic permeability of 5 or more and 50 or less, more preferably 5 or more and 20 or less. In particular, when the magnetic core of a reactor is substantially entirely formed of a composite material according to the present invention, the composite material desirably has a relative magnetic permeability of 10 or more and 20 or less.

A reactor according to the present invention can be suitably used as a component of a converter. A converter according to the present invention may have a configuration including a switching element, a drive circuit that controls operation of the switching element, and a reactor that smoothes switching operation, the switching element being configured to operate to convert an input voltage, wherein the reactor is a reactor according to the present invention. This converter according to the present invention can be suitably used as a component of a power conversion device. A power conversion device according to the present invention may have a configuration including a converter that converts an input voltage; and an inverter that is connected to the converter and performs interconversion between direct current and alternating current, the inverter being configured to supply a converted power for driving a load, wherein the converter is a converter according to the present invention.

A converter according to the present invention and a power conversion device according to the present invention include a reactor according to the present invention in which the loss is low and magnetic characteristics are less likely to be decreased. As a result, in the converter and the power conversion device, the loss is low and desired magnetic characteristics tend to be maintained.

### Advantageous Effects of Invention

In a reactor according to the present invention, the loss is low and magnetic characteristics are less likely to be decreased. A reactor core according to the present invention and a composite material according to the present invention have a maximum bubble diameter of 300 μm or less and hence can contribute to achievement of a reactor in which the loss is low and magnetic characteristics are less likely to be decreased.

### BRIEF DESCRIPTION OF DRAWINGS

FIG. 1 is a schematic perspective view of a reactor according to a first embodiment.

FIG. 2A is a sectional view taken along (A)-(A) in FIG. 1.

FIG. 2B is a sectional view taken along (B)-(B) in FIG. 1.

FIG. 3A is a micrograph of a section of an outer core portion of a reactor according to a first embodiment.

FIG. 3B is a micrograph of a section of an outer core portion of a reactor of Comparative example.

FIG. 4A is a schematic perspective view of a reactor according to a second embodiment.

FIG. 4B is a sectional view taken along (B)-(B) in FIG. 4A.

FIG. 5A is a schematic perspective view of a reactor according to a third embodiment.

FIG. 5B is a schematic perspective view of a magnetic core of this reactor.

FIG. 6 is a graph illustrating the relationship between a bubble diameter in a composite material and loss.

FIG. 7 is a graph illustrating the relationship between a bubble diameter in a composite material and inductance.

FIG. 8 is a graph illustrating the relationship between the content of bubbles in a composite material and loss.

FIG. 9 is a graph illustrating the relationship between the content of bubbles in a composite material and inductance.

FIG. 10 is a schematic configuration view schematically illustrating the power system of a hybrid electric vehicle.

FIG. 11 is a schematic circuit diagram illustrating an example of a power conversion device according to the present invention including a converter according to the present invention.

### DESCRIPTION OF EMBODIMENTS

Hereinafter, embodiments of the present invention will be described with reference to drawings. Like reference signs in the drawings denote elements having the same name.

### First Embodiment

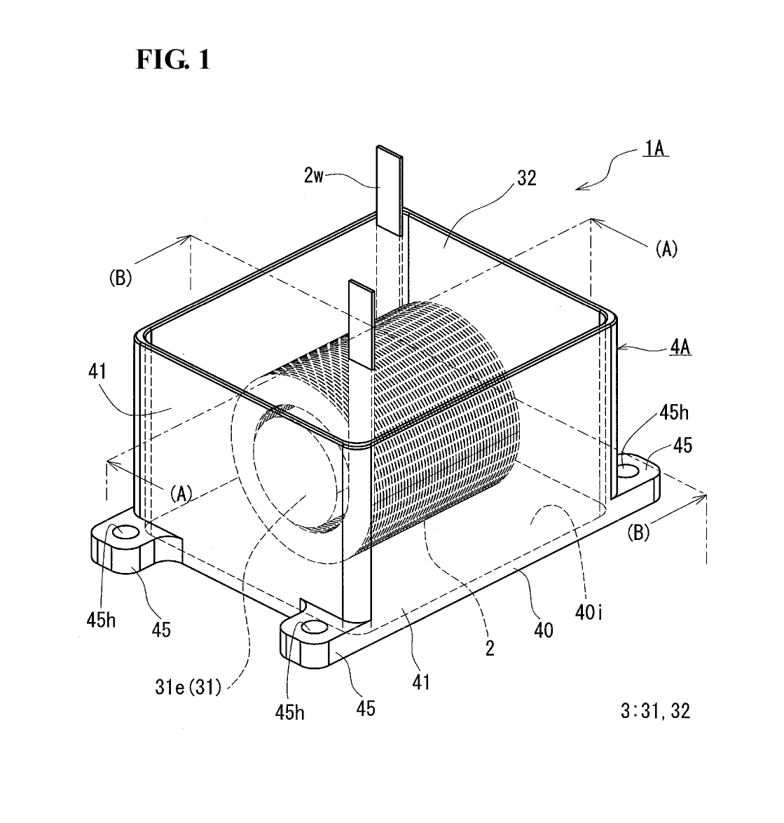

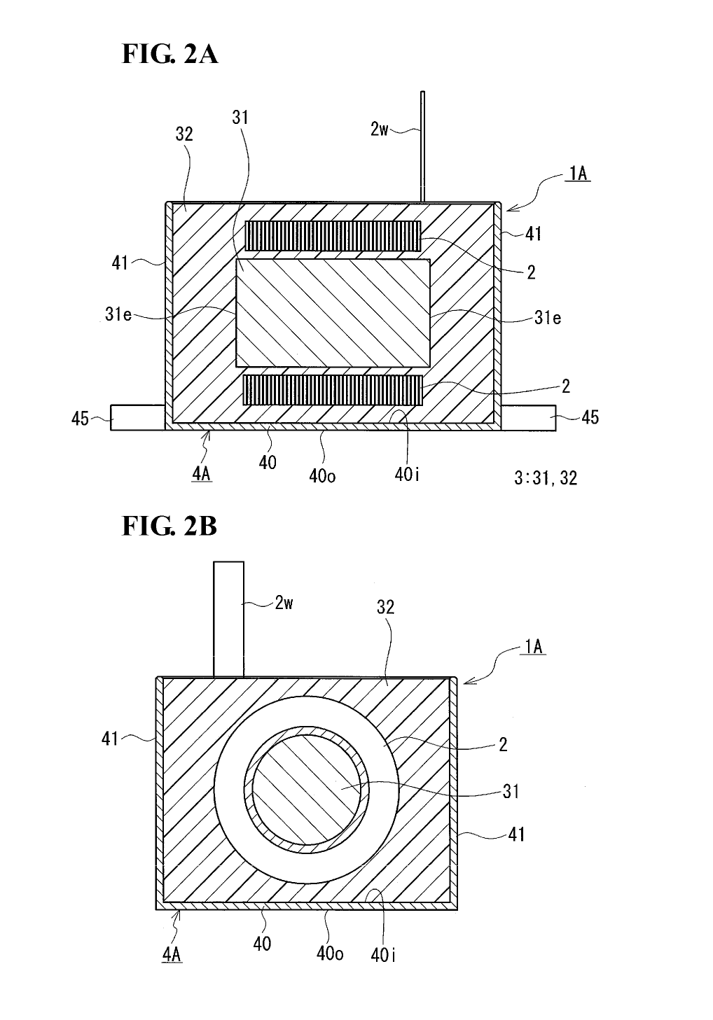

Referring to FIG. 1, FIG. 2A, and FIG. 2B, a reactor 1A in the first embodiment will be described. The reactor 1A includes a single coil 2 that has a cylindrical shape and is formed by spirally winding a wire 2w; a magnetic core 3 that is disposed inside and outside the coil 2 and forms a closed magnetic circuit; and a case 4A housing an assembly of the coil 2 and the magnetic core 3. In general, the reactor 1A is mounted on a mount base such as a cooling base having a cooling mechanism such as a circulation channel for cooling water; and the reactor 1A is used while being cooled with the cooling mechanism. The case 4A of the reactor 1A is fixed to the mount base. The magnetic core 3 includes an inner core portion 31 disposed inside the coil 2 and an outer core portion 32 disposed so as to cover the outer periphery of the coil 2. The reactor 1A has the following features: a part that is disposed outside the cylindrical coil 2, that is, the outer core portion 32 is formed of a composite material and bubbles in this composite material have a maximum diameter of 300 μm or less. Hereinafter, the configurations and a method for producing the reactor will be sequentially described.

### [Coil]

The coil 2 is a cylindrical body formed by spirally winding the wire 2w, which is a single continuous wire. The wire 2w is preferably a coated wire in which the outer periphery of a conductor formed of a conductive material such as copper, aluminum, or an alloy thereof is covered with an insulating coating formed of an insulating material (typically, an enamel material such as polyamide-imide). The conductor may be selected from wires having various shapes, such as a rectangular wire having a rectangular cross section, a round wire having a circular cross section, and a profile wire having a polygonal cross section. In particular, when a rectangular wire is wound edgewise, the resultant edgewise coil tends to have a high space factor. Accordingly, a small coil having a high space factor is easily obtained, which contributes to reduction of the size of reactors. Here, the coil 2 is an edgewise coil formed by winding edgewise a coated rectangular wire in which the conductor is constituted by a copper rectangular wire having a rectangular cross section and the insulating coating is formed of enamel.

### (Shape of End Surfaces)

As illustrated in FIG. 1 and FIG. 2B, in the coil 2, the shape of the end surfaces and the shape of cross-sections that are orthogonal to the axial direction are typically circular. Such a circular coil is easily formed by winding a wire even when the wire is a rectangular wire. Thus, the coil is produced with high productivity and is easily produced so as to have a small size. Alternatively, the shape of the end surfaces of the coil 2 may be a shape that is not circular and has a curved portion: for example, a shape substantially constituted by curves only such as an ellipse, or a shape having a curved portion and a straight-line portion (for example, a shape provided by rounding the vertices of a polygon such as a rectangle, or a race-track shape in which straight lines and circular arcs are combined). When the shape has a straight-line portion, the coil can be housed in the case such that a flat surface formed by the straight-line portion is parallel to the bottom surface of the case to thereby achieve high stability and high heat-dissipation capability.

### (Ends of Wire)

As illustrated in FIG. 1, both ends of the wire 2w constituting the coil 2 appropriately extend from the turn-formed portion; the insulating coating is removed from the ends to expose conductor portions and, to these conductor portions, terminal members (not shown) formed of a conductive material such as copper or aluminum are connected. Through these terminal members, an external device (not shown) such as a power supply that supplies power to the coil 2 is connected. The connection between a conductor portion of the wire 2w and a terminal member can be achieved by, for example, welding such as tungsten-inert gas (TIG) welding or press-bonding. Note that the direction in which both ends of the wire 2w extend is an example and the direction can be appropriately changed.

### (Configuration of Disposition)

As illustrated in FIG. 2A, the coil 2 is housed in the case 4A such that the axis of the coil 2 is substantially parallel to a bottom surface 40 of the case 4A. In short, the coil 2 is housed so as to be horizontally oriented with respect to the case 4A (hereafter, this configuration of disposition will be referred to as a horizontal configuration). The term “substantially parallel” encompasses a case where an outer bottom surface 40o and an inner bottom surface 40i are both constituted by flat surfaces and the axis of the coil 2 is parallel to the two surfaces 40o and 40i, and another case where a portion of the outer bottom surface 40o and the inner bottom surface 40i is not constituted by a flat surface and the portion is not parallel to the axis of the coil 2 (for example, the outer bottom surface 40o is constituted by a flat surface and the inner bottom surface 40i has an irregular shape).

### [Magnetic Core]

As illustrated in FIG. 2A and FIG. 2B, the magnetic core 3 includes the inner core portion 31 that has a columnar shape and is inserted through the coil 2, and the outer core portion 32 formed so as to cover at least one end surface 31e (in this case, both end surfaces) of the inner core portion 31 and the outer peripheral surface of the coil 2. When the coil 2 is excited, the magnetic core 3 forms a closed magnetic circuit. In the reactor 1A, the magnetic core 3 does not have a uniform material configuration and is formed of different materials depending on portions and have different magnetic characteristics depending on portions. Specifically, the inner core portion 31 has a higher saturation flux density than the outer core portion 32; and the outer core portion 32 has a lower relative magnetic permeability than the inner core portion 31.

### (Inner Core Portion)

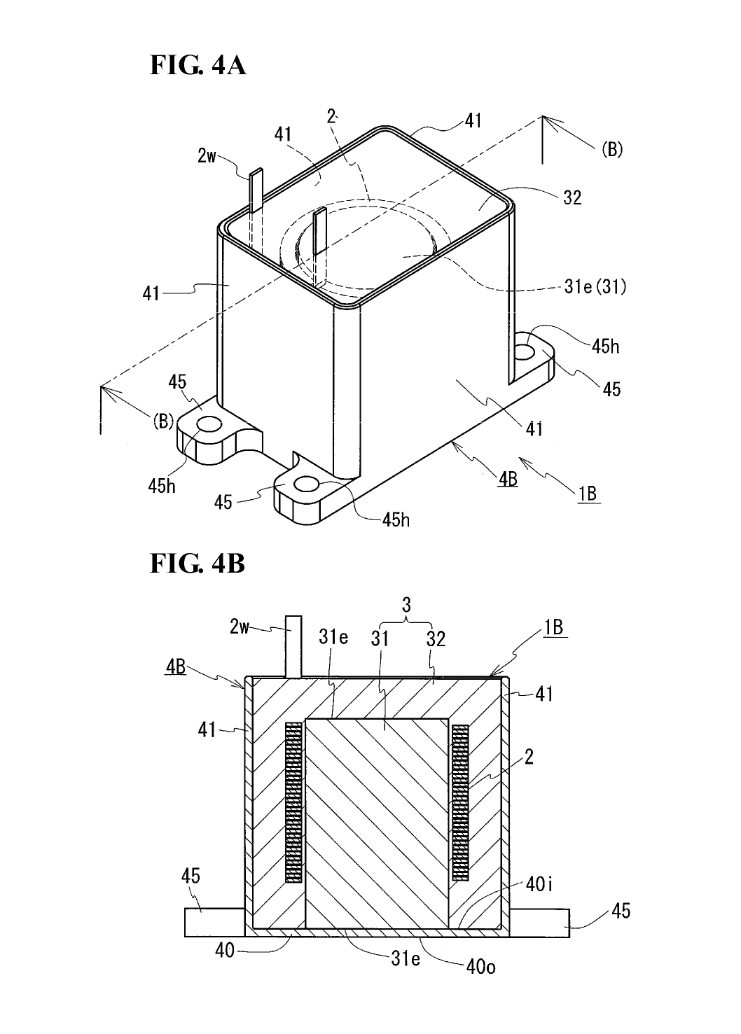

The inner core portion 31 is a cylindrical body conforming to the inner peripheral shape of the coil 2. Here, as illustrated in FIG. 2A, the length of the inner core portion 31 in the axial direction of the coil 2 (hereafter, simply referred to as length) is larger than the length of the coil 2; in the state where the inner core portion 31 is disposed inside the coil 2 so as to be inserted through the coil 2, the two end surfaces 31e and their nearby regions of the outer peripheral surface of the inner core portion 31 slightly protrude from the end surfaces of the coil 2. The protrusion length of the inner core portion 31 can be appropriately selected. Here, the inner core portion 31 protrudes by the same protrusion length from the end surfaces of the coil 2. Alternatively, the protrusion lengths may be different as in a second embodiment described below, or the length of the inner core portion or the position of the inner core portion disposed with respect to the coil may be adjusted such that the inner core portion protrudes from only one end surface of the coil 2. Alternatively, another configuration in which the length of the inner core portion is equal to the length of the coil or another configuration in which the length of the inner core portion is smaller than the length of the coil may be employed. However, as illustrated in FIG. 2A and FIG. 4B, the length of the inner core portion 31 is preferably equal to or larger than the length of the coil 2 because the magnetic flux formed by the coil 2 can sufficiently pass through the inner core portion 31.

Here, the inner core portion 31 is constituted by a compact formed of a soft magnetic material having coated films such as insulating coated films. Typically, the compact is obtained by compacting a soft magnetic powder covered with insulating coated films formed of a silicone resin or the like or a mixed powder in which this soft magnetic powder is appropriately mixed with a binder, and by subsequently firing the powder at a temperature equal to or lower than the heat-resistant temperature of the insulating coated films. In the production of the compact, the saturation flux density can be changed, for example, by adjusting the material of the soft magnetic powder, the mixing ratio of the soft magnetic powder to the binder, or the amounts of various coated films including insulating coated films or by adjusting the compacting pressure. For example, by using a soft magnetic powder having a high saturation flux density, by decreasing the amount of the binder mixed to thereby increase the proportion of the soft magnetic material, or by increasing the compacting pressure, a compact having a high saturation flux density can be obtained.

The soft magnetic powder may be, for example, a powder formed of an iron-group metal such as Fe, Co, or Ni; a powder formed of an Fe-based alloy mainly containing Fe, such as an iron-based material such as Fe—Si, Fe—Ni, Fe—Al, Fe—Co, Fe—Cr, or Fe—Si—Al; a rare-earth metal powder; or a ferrite powder. In particular, the iron-based material tends to provide a magnetic core having a high saturation flux density, compared with ferrite. The material constituting the insulating coated films formed in the soft magnetic powder is, for example, a phosphate compound, a silicon compound, a zirconium compound, an aluminum compound, or a boron compound. In particular, when magnetic particles constituting the soft magnetic powder are formed of a metal such as an iron-group metal or an Fe-based alloy, the insulating coated films formed on the magnetic particles allow an effective decrease in the eddy current loss. The binder may be, for example, a thermoplastic resin, a non-thermoplastic resin, or a higher fatty acid. Such a binder is eliminated or turned into an insulator such as silica by the above-described firing. The compact can be relatively easily formed even when its shape is a complex three-dimensional shape. In addition, an insulator such as an insulating coated film present between magnetic particles insulates the magnetic particles from each other to thereby decrease the eddy current loss; and, even when a high-frequency power is applied to the coil, the above-described loss can be decreased. The compact may be a publicly known compact. The inner core portion 31 having a columnar shape can be obtained as an integrated product through compacting with a mold having a desired shape or can be obtained as an integrated product by fixing a plurality of core pieces with an adhesive, an adhesive tape, or the like.

Here, the inner core portion 31 is a solid body including no gap member or no air gap. The absence of gaps allows size reduction. In addition, flux leakage in gap portions does not affect the coil 2 and hence the coil 2 and the inner core portion 31 can be disposed close to each other, which also contributes to reduction of the size of the reactor 1A. Furthermore, omission of gap allows a decrease in the loss and suppression of a decrease in the inductance during supply of a large current. Alternatively, the magnetic core 3 may have a configuration including a material having a lower relative magnetic permeability than the compact and a composite material described below, that is, a gap member formed of a non-magnetic material such as, typically, an alumina plate, or air gap; or a configuration including a gap member having a relative magnetic permeability of more than 1. A material constituting this gap member may be a non-magnetic material (for example, a resin such as unsaturated polyester) in which a magnetic powder of iron, Fe—Si, or the like is dispersed. The presence of a gap member having a relative magnetic permeability of more than 1, that is, a gap member having magnetism, facilitates adjustment of the inductance of the reactor. In order not to make the thickness of the gap member excessively large, the gap member preferably has a relative magnetic permeability of more than 1 and 5 or less, more preferably 1.1 or more and 1.4 or less.

### (Outer Core Portion)

Here, the outer core portion 32 covers substantially the entirety of the outer peripheral surface and the two end surfaces of the coil 2 and the two end surfaces 31e and their nearby regions of the outer peripheral surface of the inner core portion 31. The outer core portion 32 has a shape conforming to the space formed by the inner peripheral surface of the case 4A and the outer peripheral surface of the assembly of the coil 2 and the inner core portion 31 housed in the case 4A.

The outer core portion 32 is disposed such that regions thereof are connected to the two end surfaces 31e of the inner core portion 31. As a result, the magnetic core 3 forms a closed magnetic circuit.

The outer core portion 32 is entirely formed of a composite material containing a magnetic powder and a resin. In a section of this composite material, the maximum bubble diameter is 300 μm or less.

The composite material containing a magnetic powder and a resin can be typically produced by injection molding or cast molding. In injection molding, in general, a magnetic powder and a resin having flowability (liquid resin) are mixed; this fluid mixture is injected into a mold (including the case 4A) under application of a predetermined pressure so as to have a shape; and the resin is subsequently cured to thereby provide the composite material. In cast molding, a fluid mixture is obtained as in the injection molding; and this fluid mixture is then injected into a mold without application of pressure so as to have a shape and curing is performed to thereby provide the composite material. In particular, a composite material having a maximum bubble diameter of 300 μm or less can be obtained by preparing a fluid mixture and charging the fluid mixture into a mold under specific conditions described below, and also by performing a specific degassing step. In the first embodiment, the case 4A is used as a mold. In this case, even a composite material having a complex shape can be easily molded. A plurality of molded bodies having desired shapes may be prepared and combined to thereby form a magnetic core having a desired shape.

### [Bubbles]

The above-described section of the composite material may be a section provided by cutting in the axial direction of the coil 2 or a section provided by cutting in a direction orthogonal to the axial direction. The maximum bubble diameter is determined as follows: a plurality of sections (for example, 10 sections) of the composite material corresponding to a field of view having a certain size (for example, 5 mm×7 mm) are prepared; on the basis of contours of bubbles present in the sections, equivalent circle diameters of the contours (diameters of circles having the same areas as bubbles, the circles being determined on the basis of the contours of the bubbles recognized in the sections) are calculated and the equivalent circle diameters are regarded as the diameters of the bubbles; and the maximum value of the diameters of the bubbles in the plurality of sections is determined. By observing the sections with an optical microscope or the like (at a magnification of about 10 to about 50 times) and subjecting observed images to image processing with a commercially available image processing system, extraction of the contours of bubbles and calculation of equivalent circle diameters can be easily performed. In view of influences on the magnetic characteristics and the loss, the bubbles are preferably as small as possible. Accordingly, the maximum bubble diameter is preferably as small as possible, that is, 200 μm or less, more preferably 100 μm or less.

When a large number of bubbles having a maximum diameter of 300 μm or less are present, as in the case where large bubbles are present, circumvention of magnetic flux due to the bubbles may cause local variations in the distribution of lines of magnetic induction in the composite material, which may result in a decrease in magnetic characteristics or a decrease in the thermal conductivity. For this reason, in addition to the feature that the maximum bubble diameter is 300 μm or less, the number of the bubbles is preferably as small as possible. That is, the content of the bubbles itself is preferably as low as possible. Specifically, the total area percentage of bubbles in such a section of the composite material is preferably 1% or less. Furthermore, the total area percentage of bubbles in such a section of the composite material is more preferably equal to or less than, in the case of the presence of a single spherical bubble having a diameter of 300 μm, the area percentage of a sectional circle crossing the diameter of this bubble, specifically, 0.2% or less. Note that the area of a sectional circle crossing the diameter of a spherical bubble having a diameter of 300 μm (0.3 mm) is as follows: (the square of the 0.15-mm radius)×π≈0.07 mm². Accordingly, when this spherical bubble alone is present, the area percentage of a sectional circle crossing the diameter of this bubble with respect to the sectional area in a field of view having a size of 5 mm×7 mm (35 mm²) is as follows: (0.07/35)×100=0.2%.

The above-described total area percentage denotes the total area percentage of bubbles with respect to the sectional area in the above-described field of view having a size of 5 mm×7 mm. The field of view may have, for example, a rectangular shape or a square shape as long as it has an area of 35±5 mm².

### [Magnetic Powder]

The magnetic powder of the composite material constituting the outer core portion 32 may have the same or a different composition to the above-described soft magnetic powder of the compact constituting the inner core portion 31. The composite material constituting the outer core portion 32 has a relatively high content of a resin which is a non-magnetic material. Accordingly, even when the magnetic powder is a soft magnetic powder having the same composition as the compact constituting the inner core portion 31, the outer core portion 32 has a lower saturation flux density and a lower relative magnetic permeability than the compact. The magnetic powder constituting the outer core portion 32 is preferably a powder formed of an iron-based material such as a pure iron powder or an Fe-based alloy powder. The magnetic powder may be a mixture of a plurality of powders composed of different materials. In particular, in the case where the magnetic powder is composed of a metal material, when this powder is a coated powder having, on the surfaces of particles constituting this powder, insulating coated films formed of a phosphate or the like, the eddy current loss can be decreased.

The magnetic powder of the composite material constituting the outer core portion 32 preferably has an average particle size of 1 μm or more and 1000 μm or less, in particular, 10 μm or more and 500 μm or less. Here, the magnetic powder of the composite material constituting the outer core portion 32 has substantially the same size as a powder used as the raw material (the size is maintained). When a powder having a size in such a range is used as the raw-material powder, the fluid mixture has high flowability and hence the composite material can be produced with high productivity. The magnetic powder may contain a plurality of powders having different particle sizes. By using a composite material in which a magnetic powder contains a fine powder and a coarse powder to constitute the magnetic core, a reactor having a high saturation flux density and exhibiting a low loss is easily obtained.

The content of the magnetic powder in the composite material constituting the outer core portion 32 with respect to the composite material (100%) may be 30% by volume or more and 70% by volume or less, 40% by volume or more and 65% by volume or less, in particular, 40% by volume or more and 60% by volume or less. When the content of the magnetic powder is 30% by volume or more, the proportion of the magnetic component is sufficiently high and hence magnetic characteristics such as saturation flux density are easily increased. In particular, in the case where the magnetic powder is composed of a material having a saturation flux density of about 2 T such as iron or an Fe—Si alloy, when the content of the magnetic powder is 30% by volume or more, a saturation flux density of 0.6 T or more is easily achieved; and, when the content is 40% by volume or more, a saturation flux density of 0.8 T or more is easily achieved. When the content of the magnetic powder is 70% by volume or less, mixing between the magnetic powder and the resin can be easily performed during production and high productivity is achieved.

### [Resin]

Typical examples of the resin serving as a binder in the composite material constituting the outer core portion 32 include thermosetting resins such as epoxy resins, phenol resins, silicone resins, urethane resins, and unsaturated polyesters. Other usable resins serving as binders include thermoplastic resins, cold-setting resins, and low-temperature setting resins. Examples of the thermoplastic resins include polyphenylene sulfide (PPS) resins, polyimide resins, and fluorocarbon resins.

### [Other Components Contained]

In a configuration of the composite material, a magnetic powder and a resin serving as a binder may be mixed with a filler (typically, a non-magnetic powder) formed of a ceramic such as alumina or silica. By adding the filler having a lower specific gravity than the magnetic powder, non-uniform distribution of the magnetic powder can be suppressed to provide a composite material in the entirety of which the magnetic powder is uniformly dispersed. When the filler is composed of a material having high thermal conductivity, the filler can contribute to enhancement of the heat-dissipation capability. The content of the filler with respect to the composite material (100% by mass) may be 0.2% by mass or more. The higher the content of the filler, the more advantageous the effects such as suppression of non-uniform distribution of the magnetic powder and enhancement of the heat-dissipation capability. Accordingly, the content of the filler is preferably 0.3% by mass or more, more preferably 0.5% by mass or more. However, when the content of the filler is excessively high, the proportion of the magnetic powder becomes low. Accordingly, the content of the filler is preferably 20% by mass or less, more preferably 15% by mass or less, in particular, preferably 10% by mass or less. When the filler has a smaller particle size than the magnetic powder, the filler tends to be present between the magnetic particles and a decrease in the proportion of the magnetic powder due to the addition of the filler is easily suppressed.

Here, the outer core portion 32 is constituted by a composite material containing an epoxy resin and a coated powder having the insulating coated films on the surfaces of particles formed of an iron-based material (pure iron) and having an average particle size of 75 μm or less (the content of the pure iron powder in the composite material: 45% by volume).

### [The Distribution State of Magnetic Powder]

In a typical configuration of the magnetic powder in the composite material, magnetic particles constituting the powder are uniformly dispersed in the composite material. Alternatively, as described below, by increasing the holding time in the degassing step, another configuration in which the magnetic powder is distributed in a larger amount on the bottom-surface side of the mold (here, the bottom surface 40 side of the case 4A) can be provided. Specifically, regarding this configuration, in the outer core portion 32, in comparison between the proportion of the magnetic powder distributed on the bottom surface 40 side of the case 4A and the proportion of the magnetic powder distributed on the opening side opposite to the bottom surface 40, the distribution proportion on the bottom surface 40 side is larger.

### [Shape]

The shape of the outer core portion 32 is not particularly limited as long as a closed magnetic circuit can be formed. Here, as described above, the composite material constituting the outer core portion 32 covers substantially the entire periphery of the assembly of the coil 2 and the inner core portion 31. Accordingly, the outer core portion 32 also functions as a sealing material for the coil 2 and the inner core portion 31 to enhance the protection of the coil 2 from the external environment and the mechanical protection of the coil 2.

For example, a configuration may be provided in which a portion of the outer periphery of the coil 2 is not covered by the composite material constituting the outer core portion 32. Specific examples of this configuration include a configuration in which a region in the outer peripheral surface of the coil 2, the region being positioned on the opening side of the case 4A, is exposed without being covered by the composite material; and a configuration in which a groove that can house a portion of a region of the coil 2, the region being positioned on the bottom-surface side, is formed in the bottom surface of the case 4A and the portion housed in this groove is not covered by the composite material. In such a configuration, in the coil 2, a region positioned on the opening side and being farthest from the bottom surface of the case 4A is exposed or the area in contact with the case 4A is increased and, as a result, the heat-dissipation capability is enhanced. In the configuration in which a region of the coil 2 is exposed, a lid covering the opening of the case is preferably provided. When this lid is formed of a conductive material such as metal (may be the same material as in the case), flux leakage from the exposed region of the coil 2 to the outside can be suppressed and this lid can also be used as a heat-dissipation path.

Alternatively, another configuration may be provided in which a positioning member (not shown) for the coil 2 is additionally disposed on the inner bottom surface 40i of the case 4A and regions of the coil 2 that are in contact with the positioning member are not covered by the composite material constituting the outer core portion. The material of the positioning member is preferably an insulating material for the purpose of enhancing insulation between the coil 2 and the case 4A; and, when this material has high heat-dissipation capability, the heat-dissipation capability can be enhanced. The positioning member and the coil 2 are sealed with the composite material constituting the outer core portion 32 so that the relative positions of the positioning member and the coil 2 are fixed.

A configuration may be provided in which a region of the inner core portion 31 is not covered by the composite material constituting the outer core portion 32. In an example of this configuration, a support member that supports regions of the inner core portion 31 that protrude from the end surfaces of the coil 2 is provided, and regions of the inner core portion 31 that are in contact with the support member are not covered by the composite material. The support member determines the position of the inner core portion 31 with respect to the case 4A; and, as a result of the determination of the position of the inner core portion 31, the position of the coil 2 can also be determined. In addition, fixing at these positions is achieved by sealing with the composite material constituting the outer core portion 32. Accordingly, when the support member is provided, the above-described positioning member for the coil 2 may be omitted. When the inner core portion 31 and the coil 2 are fixed at appropriate positions, the inductance is easily made to be the set value. The support member may be a member integrally formed as a part of the case 4A or may be an independent member formed from the composite material or another material. By also forming the support member from a material having high heat-dissipation capability, the heat-dissipation capability can be enhanced. In a configuration in which the size of the support member is adjusted such that, while the support member supports the inner core portion 31, a gap is formed between the coil 2 and the inner bottom surface 40i of the case 4A, insulation between the coil 2 and the inner bottom surface 40i can be enhanced; and, in a configuration in which the coil 2 and the inner bottom surface 40i are in contact with each other, the heat-dissipation capability can be enhanced.

### [Bonding Between Inner Core Portion and Outer Core Portion]

Bonding between the inner core portion 31 and the outer core portion 32 is achieved not by an adhesive but by the resin of the composite material constituting the outer core portion 32. Here, the outer core portion 32 also does not include any gap member or air gap. The magnetic core 3 is thus an integrated member the entirety of which does not include any gap member. Accordingly, regarding the reactor 1A, the production of the magnetic core 3 does not require a bonding step using an adhesive or the like and hence the reactor 1A can be produced with high productivity.

Alternatively, bonding between the inner core portion 31 and the outer core portion 32 may be achieved with an adhesive. In another configuration in which gap members are provided, bonding between the inner core portion 31, the outer core portion 32, and the gap members may be achieved with an adhesive. When bonding with an adhesive is performed, the bonding may be performed by a plurality of independent bonding steps. When the amount of the adhesive is sufficiently small, it is considered that the adhesive does not substantially function as gap members.

### (Magnetic Characteristics)

Here, the inner core portion 31 has a saturation flux density that is 1.6 T or more and 1.2 or more times that of the outer core portion 32 and has a relative magnetic permeability of 100 or more and 500 or less; the outer core portion 32 has a saturation flux density that is 0.5 T or more and less than that of the inner core portion 31 and has a relative magnetic permeability of 5 or more and 30 or less; and the entirety of the magnetic core 3 constituted by the inner core portion 31 and the outer core portion 32 (in the case where gap members and air gap are not substantially interposed) has a relative magnetic permeability of 10 or more and 100 or less. In the case of obtaining a certain magnetic flux, the higher the absolute value of the saturation flux density of the inner core portion and the larger the saturation flux density of the inner core portion relative to the outer core portion, the easier it is to make the sectional area of the inner core portion smaller. Accordingly, in a configuration in which the inner core portion has a high saturation flux density, in the case of obtaining the same magnetic flux as in a magnetic core the entirety of which has a uniform saturation flux density, the sectional area of the inner core portion can be reduced, which can contribute to reduction of the size of the reactor. The inner core portion 31 preferably has a saturation flux density of 1.8 T or more, more preferably 2 T or more, but the upper limit thereof is not defined; and the inner core portion 31 preferably has a saturation flux density that is 1.5 or more times, more preferably 1.8 or more times, that of the outer core portion 32, but the upper limit thereof is not defined. By using, instead of the compact, a laminated structure of magnetic steel sheets represented by silicon steel sheets, the saturation flux density of the inner core portion tends to be further increased. On the other hand, when the relative magnetic permeability of the outer core portion 32 is lower than that of the inner core portion 31, for example, magnetic flux tends to pass through the inner core portion 31. By providing a portion having a low relative magnetic permeability, magnetic saturation can be suppressed and hence the magnetic core 3 having a gapless structure can be provided.

### [Interposed Member Between Coil and Magnetic Core]

In order to enhance the insulation between the coil 2 and the magnetic core 3, a configuration in which an insulating member is interposed between the coil 2 and the magnetic core 3 may be provided. For example, an insulating tape may be attached to the outer peripheral surface or the inner peripheral surface of the coil 2, or the outer peripheral surface or the inner peripheral surface of the coil 2 may be covered by an insulating paper or an insulating sheet. Alternatively, a cylindrical insulator may be disposed outside the inner core portion 31 or outside the coil 2. Materials that can be suitably used for forming the insulator are insulating resins such as PPS resins, liquid crystal polymers (LCPs), and polytetrafluoroethylene (PTFE) resins. When the insulator is constituted by separable pieces that can be separated in the radial direction of the inner core portion 31 or the coil 2, the insulator can be easily disposed outside the inner core portion 31 or outside the coil 2. When a cylindrical body is provided that is disposed outside the inner core portion 31 and has a configuration having annular flanges protruding from the peripheral edges of both ends to the outside, the end surfaces of the coil 2 can be covered by the flanges.

Alternatively, for example, a configuration of a coil molded product in which the outer peripheral surface, the inner peripheral surface, and the end surfaces of the coil 2 are covered by an insulating resin may be provided. By adjusting the thickness of the resin covering the inner peripheral surface of the coil 2, this resin can be used to determine the position of the inner core portion 31. Alternatively, a coil molded product in which the coil 2 and the inner core portion 31 are integrally molded with an insulating resin may be provided. In this case, the integrated product of the coil 2 and the inner core portion 31 is easily housed in the case 4A. The insulating resin can also have a function of maintaining the shape of the coil 2 or maintaining the coil 2 in a state of being compressed from its natural-length state. As described above, the coil molded product allows easy handling of the coil 2 and a decrease in the axial length of the coil 2. In the coil molded product, the thickness of the resin may be, for example, about 1 mm to about 10 mm. The coil molded product can be produced by, for example, the production method described in Japanese Unexamined Patent Application Publication No. 2009-218293. The molding may be performed by injection molding, transfer molding, or cast molding. The resins that can be suitably used as the insulating resin are thermosetting resins such as epoxy resins and thermoplastic resins such as PPS resins and LCPs. When the insulating resin mixed with a filler composed of at least one ceramic selected from silicon nitride, alumina, aluminum nitride, boron nitride, and silicon carbide is used, the heat-dissipation capability can be enhanced.

In the coil 2, compared with the turn-formed portion, a high voltage may be applied to extensions of the wire 2w that extend from the turn-formed portion. Accordingly, in at least portions of the extensions of the wire 2w, the portions being in contact with the magnetic core 3 (the outer core portion 32), the portions may be covered by the insulating resin; an insulating material such as an insulating paper, an insulating tape (for example, a polyimide tape), or an insulating film (for example, a polyimide film) may be wound around the portions; the portions may be dip-coated with an insulating material; or an insulating tube (a heat-shrinkable tube or a cold-shrinkable tube) may be disposed in the portions. As a result, insulation between the coil 2 and the magnetic core 3 (here, in particular, the outer core portion 32) can be enhanced.

### [Case]

Typically, the case 4A may be a rectangular-parallelepiped-box member constituted by the bottom surface 40 having the shape of a rectangular plate and a side wall 41 that has the shape of a rectangular frame and is erected from the bottom surface 40, the member having an opening on the side opposite to the bottom surface 40. Note that the bottom surface 40 of the case 4A denotes, when the reactor 1A is mounted on a mount base, a surface that is in contact with the mount base. Here, the configuration in which the bottom surface 40 faces downward is illustrated; alternatively, the bottom surface 40 may face sideward (in FIG. 1, leftward or rightward) or upward. When the case 4A is mounted on a mount base such as a cooling base, the bottom surface 40 serves as a cooling surface and heat of the coil 2 is conducted through the case 4A to the mount base so that the coil 2 is cooled.

Typically, the case 4A is used as a housing that houses the assembly of the coil 2 and the magnetic core 3 to protect the assembly from the external environment in terms of dust and corrosion and to mechanically protect the assembly; and the case 4A is also used as a heat-dissipation path. Accordingly, a material that can be suitably used for constituting the case 4A is a material having high thermal conductivity, preferably a material having a higher thermal conductivity than magnetic powder of iron or the like, for example, a metal such as aluminum, an aluminum alloy, magnesium, or a magnesium alloy. These aluminum, magnesium, and alloys thereof are lightweight and hence are also suitable as materials for constituting vehicle components in which reduction in the weight is demanded. In addition, since aluminum, magnesium, and alloys thereof are non-magnetic materials and also conductive materials, flux leakage to the outside of the case 4A can be effectively suppressed. Here, the case 4A is constituted by an aluminum alloy.

As illustrated in FIG. 2A and FIG. 2B, the bottom surface 40 may have front and back surfaces (the inner bottom surface 40i and the outer bottom surface 40o) that are flat surfaces. Alternatively, as described above, by employing a configuration in which a groove conforming to the outer peripheral shape of the coil 2 or a support member supporting the inner core portion 31 is provided, heat of the coil 2 or the inner core portion 31 is easily conducted to the case 4A and the heat-dissipation capability can be enhanced. In addition, by employing a configuration in which a heat-dissipation fin or the like is provided on the side wall 41, the heat-dissipation capability can be enhanced.

In addition, as illustrated in FIG. 1, the case 4A is equipped with mounting parts 45 having bolt holes 45h for fixing the reactor 1A to a mount base with fixing parts such as bolts. The presence of the mounting parts 45 allows easy fixing of the reactor 1A to a mount base with fixing parts such as bolts. The case 4A having such a configuration can be easily produced by casting, cutting, plastic working, or the like.

In order to enhance the insulation between the coil 2 and the case 4A, a configuration in which the above-described insulating material is disposed between the coil 2 and the case 4A may be employed. This insulating material may be disposed such that the minimum insulation required between the coil 2 and the case 4A can be ensured; when the insulating material is as thin as possible, the heat-dissipation capability can be enhanced and size reduction can also be achieved. When the insulating material is formed of a material having high thermal conductivity, the heat-dissipation capability can be further enhanced. When the insulating material is an insulating adhesive, the coil 2 can be fixed to the case 4A with certainty and insulation can also be ensured. In particular, when this adhesive has high thermal conductivity, for example, an adhesive containing a filler having high thermal conductivity and high electrical insulation such as alumina, the heat-dissipation capability can be enhanced.

The reactor 1A has a horizontal configuration in which the coil 2 is housed so as to be horizontally oriented with respect to the case 4A. In the horizontal configuration, the contact area between the outer peripheral surface of the coil 2 and the inner bottom surface 40i of the case 4A tends to be large, and a region of the outer peripheral surface of the coil 2, the region being close to the inner bottom surface 40i of the case 4A, that is, the region that is close to the mount base tends to be large. Accordingly, in the horizontal configuration, the heat of the coil 2 can be efficiently conducted to the case 4A and this heat is conducted, through the outer bottom surface 40o of the case 4A in contact with the mount base, to the mount base. Therefore, the horizontal configuration has high heat-dissipation capability.

### [Applications]

The reactor 1A having such a configuration described above can be suitably used in applications under electrical conditions in which, for example, the maximum current (direct current) is about 100 A to about 1000 A, the average voltage is about 100 V to about 1000 V, and the frequency used is about 5 kHz to about 100 kHz: typically, a component of a vehicle-mounted power conversion device for an electric vehicle or a hybrid electric vehicle.

### [Size of Reactor]

When the reactor 1A is used as a vehicle-mounted component, the reactor 1A including the case 4A preferably has a volume of about 0.2 liters (200 cm³) to about 0.8 liters (800 cm³). Specifically, in the case of a coil having circular end surfaces, the inner diameter may be 20 mm to 80 mm and the number of turns may be 30 to 70; in the case of an inner core portion having a cylindrical shape, the diameter may be 10 mm to 70 mm and the height (length in the axial direction) may be 20 mm to 120 mm; and, a side of the bottom surface of a rectangular-parallelepiped-box case may have a length of 30 mm to 100 mm. In this example, the volume is about 500 cm³.

### [Method for Producing Reactor]

The reactor 1A including the outer core portion 32 formed of a composite material having a maximum bubble diameter of 300 μm or less can be produced in the following manner.

### (Preparation Step)

The case 4A serving as a mold and the assembly of the coil 2 and the inner core portion 31 to be housed in the case 4A are first prepared. A configuration may be employed in which the above-described insulating material is interposed between the coil 2 and the inner core portion 31.

### (Mixing Step)

A desired magnetic powder and a desired resin and optionally a non-magnetic powder are prepared, placed in a vessel, and mixed and stirred to prepare a fluid mixture. In particular, during this mixing step, degassing is performed. The degassing may be performed by vacuuming. The ultimate degree of vacuum in the mixing step is preferably about 10 Pa to about 1000 Pa. Here, about 500 Pa was selected. The mixing step has the highest possibility of introduction of gas (mainly the air) from the atmosphere and the introduced gas tends to remain as bubbles in the composite material. Accordingly, by performing mixing under degassing, the size and number of bubbles in the composite material are easily reduced. This mixing step can be easily performed with a commercially available stirring apparatus equipped with a degassing mechanism that allows degassing of the vessel. Note that the mixing step can be performed at room temperature (about 20° C. to about 25° C.).

### (Charging Step)

In general, the higher the temperature of a thermosetting resin and a thermoplastic resin, the lower the viscosity and the higher the flowability. Accordingly, in charging of the fluid mixture from the mixing step into a mold (here, the case 4A), the temperature of the fluid mixture is increased. This temperature is, by 5° C. or more and 20° C. or less, lower than the temperature Tmin at which the fluid mixture exhibits the minimum viscosity. Specifically, this temperature T₁ is selected from (Tmin−20)° C. to (Tmin−5)° C. By setting the temperature of the fluid mixture to T₁ (° C.), the fluid mixture can be made to exhibit such a low viscosity that it is easily charged.

The temperature Tmin of a desired fluid mixture can be determined by mixing a desired magnetic powder, a desired resin, and optionally a non-magnetic powder at desired proportions to prepare the fluid mixture and by examining the relationship between the temperature and viscosity of the fluid mixture in advance. The temperature T₁ can be determined on the basis of the temperature Tmin. In the case where magnetic powders and resins having various compositions are prepared, a plurality of fluid mixtures with different mixing amounts are produced in advance, and the viscosity-temperature relationships of these fluid mixtures are determined in advance to provide measurement data, by referring to this measurement data, the temperature Tmin of a desired fluid mixture can be easily determined.

In addition, the temperature of the mold (here, the case 4A housing the prepared assembly) is also set to temperature T₂ (° C.) selected from the above-described temperature range of (Tmin−20)° C. to (Tmin−5)° C. As a result, the temperature difference between the fluid mixture and the mold is small (15° C. at the maximum). The temperature difference between the fluid mixture and the mold may be eliminated so that the fluid mixture and the mold are set to the same temperature (T₁=T₂). By setting both of the fluid mixture and the mold to the predetermined temperatures (T₁, T₂), compared with the case where at least one of the fluid mixture and the mold is at room temperature, bubbles in the fluid mixture are easily discharged. In addition, since the temperature difference between the fluid mixture and the mold is small (15° C. at the maximum), the following phenomenon can be suppressed: the fluid mixture charged into the mold is heated by the mold to thereby cause an increase in the viscosity or the fluid mixture is cooled by the mold to thereby make discharge of the bubbles difficult. The fluid mixture at the temperature T₁ (° C.) is charged into the mold at the temperature T₂ (° C.). By also vacuuming during the charging (preferably, the ultimate degree of vacuum is 1000 Pa or less), the amount of the bubbles tends to be further reduced. The charging step may be performed by placing the mold in a thermostat so that the mold can be maintained at a constant temperature. Here, the temperature Tmin was 80° C. and the temperature T₁ of the fluid mixture and the temperature T₂ of the mold (case 4A) were set to 70° C. ((Tmin−10)° C.).

### (Degassing Step)

After the fluid mixture is charged into the mold (here, the case 4A), the fluid mixture is held, under degassing, at a temperature of Tmin±5 (° C.) for a predetermined time. As a result of holding the fluid mixture at and around the temperature Tmin (° C.), the fluid mixture exhibits the minimum viscosity and hence bubbles in the fluid mixture tend to move and are easily discharged from the fluid mixture. In addition, by vacuuming for degassing, bubbles having been discharged from the fluid mixture can be discharged to the outside with certainty. In particular, by setting the ultimate degree of vacuum to 1 Pa or less, discharge of the bubbles is facilitated.

The holding temperature is preferably Tmin±3 (° C.), more preferably Tmin (° C.). The ultimate degree of vacuum is preferably 0.1 Pa or less, more preferably 0.01 Pa (1×10⁻² Pa) or less. The holding time depends on, for example, the viscosity of the resin of the fluid mixture or the content of the magnetic powder of the fluid mixture. For example, the holding time may be about 10 minutes to about 20 minutes. The degassing step can be performed by vacuuming while the mold (here, the case 4A) is placed within a thermostat. Here, a holding temperature of 80° C., a holding time of about 15 minutes, and an ultimate degree of vacuum of 1×10⁻² Pa were employed. Note that the viscosity of the resin and the viscosity of the fluid mixture at 80° C. were measured with a commercially available standard viscometer, and the resin was found to have a viscosity of about 1 Pa·s and the fluid mixture was found to have a viscosity of about 4 Pa·s.

Here, conventionally, in the case of producing a composite material, in order to achieve a state where a magnetic powder is uniformly dispersed in the composite material, after the fluid mixture is charged into a mold (including a case), the resin has been cured as quickly as possible before sedimentation of the magnetic powder occurs. In contrast, in the present invention, after the charging of the fluid mixture, the step of not only simply vacuuming but also holding the fluid mixture for a predetermined time at a temperature at which the fluid mixture exhibits the minimum viscosity is deliberately performed. Accordingly, the present invention may have a configuration in which the amount of the magnetic powder in the obtained composite material is larger on the bottom surface side of the mold (here, the case 4A) than on the opening side of the mold. In particular, when the above-described holding time is increased (for example, 30 minutes or more), a configuration in which the magnetic powder is concentrated on the bottom surface side of the mold (here, the case 4A) tends to be provided. By adding the above-described filler formed of a non-magnetic powder, non-uniform distribution of the magnetic powder in the composite material can be suppressed. Note that, in the case of the horizontal configuration, non-uniform distribution of the magnetic powder concentrated on the bottom surface side of the case 4A has less impact on the inductance than in a vertical configuration described below. In addition, by using the magnetic powder concentrated on the bottom surface side of the case as a heat-dissipation path, the heat of the coil can be easily conducted to the bottom surface of the case and the heat-dissipation capability can be enhanced.

### (Curing Step)

After the degassing step, the resin is cured. The curing temperature may be appropriately selected depending on the resin. In the case of increasing the crosslinking density of the resin, a two-stage curing step of holding the resin at the curing temperature and then holding the resin at a temperature allowing an increase in the crosslinking density may be performed. In the curing step, it is not necessary to vacuum; however, when a vacuum is created in the thermostat during the degassing step and the curing step is subsequently performed in the thermostat, curing may be performed in the vacuum state. Here, the above-described two-stage curing step was performed in which the first stage was performed at a holding temperature of 120° C. for a holding time of 2 hours and the second stage was performed at a holding temperature of 150° C. for a holding time of 4 hours. As a result of curing of the resin, the outer core portion 32 can be formed and, at the same time, the reactor 1A can be provided.

In the case where a cold-setting resin or a low-temperature setting resin is used as the resin of the composite material, by using a resin that has a sufficiently low viscosity at room temperature or a predetermined low temperature and by employing, in the above-described production method, conditions other than temperature conditions (stirring under degassing and holding for a predetermined time under degassing), a composite material having a maximum bubble diameter of 300 μm or less can be obtained.

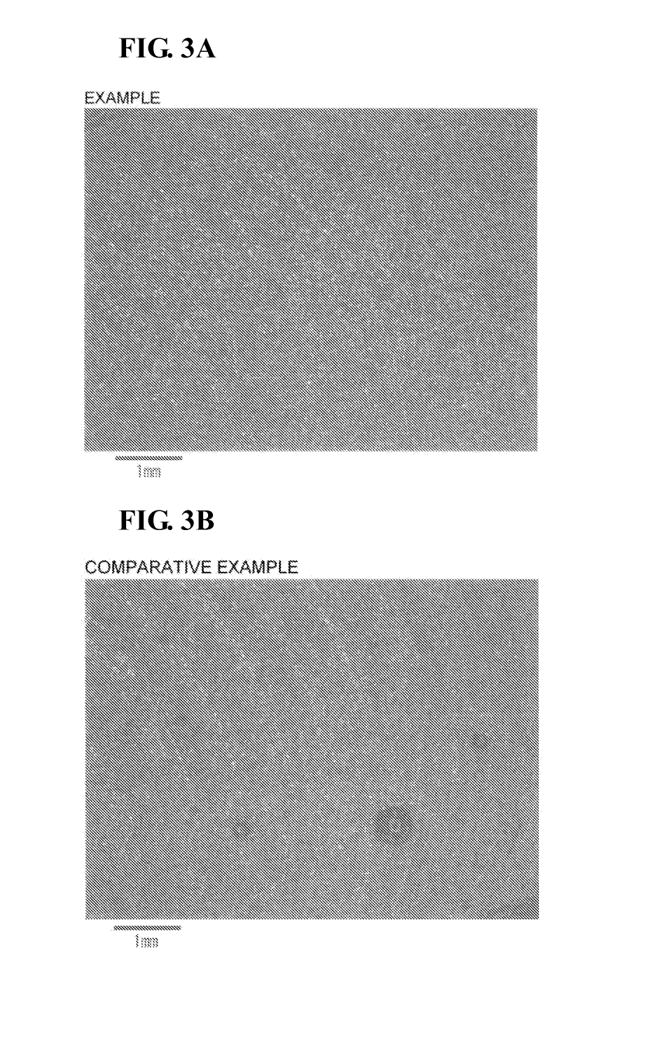

FIG. 3A: Example shows a micrograph of a section of the outer core portion 32 of the reactor 1A. As shown in FIG. 3A, as a result of formation of the outer core portion 32 by the production method including the above-described specific degassing step, the maximum bubble diameter in the composite material constituting the outer core portion 32 is 300 μm or less. In addition, in this example, the number of bubbles is very small and bubbles are not substantially present. On the other hand, in Comparative example, the above-described specific degassing step was not performed: immediately after the above-described charging step was performed, the curing step was performed to produce a reactor; and a section of the outer core portion was similarly observed with the microscope. As a result, as shown in FIG. 3B, in the reactor of Comparative example, the composite material constituting the outer core portion contains bubbles having a maximum diameter of more than 300 μm (0.3 mm). In this example, the maximum bubble diameter is 500 μm (0.5 mm) or more and the number of bubbles is also large. The area percentage of the bubbles in a section of the composite material (regarding all the bubbles present in the section (5 mm×7 mm) of the composite material, the percentage of the total area of the bubbles with respect to the section (5 mm×7 mm)) was found to be 1.4%. Other sections of the composite material were similarly observed and the area percentage of the bubbles was similarly measured; the area percentage of the bubbles was found to be 2.8% and 3.7%. As described above, in the composite material contained in the reactor in Comparative example, large bubbles were present and the area percentage of the bubbles in each section of the composite material was not 1% or less.

### [Advantages]

In the reactor 1A, a portion of the magnetic core 3 is constituted by a composite material containing a magnetic powder and a resin and, in the composite material, the maximum bubble diameter is 300 μm or less. Accordingly, the loss can be decreased and a decrease in magnetic characteristics can be suppressed. Therefore, the reactor 1A is a reactor exhibiting a low loss and having excellent magnetic characteristics.

In addition, in the reactor 1A, the outer core portion 32 is formed of the composite material. Accordingly, even when the outer core portion 32 has a complex shape of partially covering the coil 2 or the inner core portion 31, the outer core portion 32 can be easily formed.

Furthermore, in the reactor 1A, the outer core portion 32 is formed of the composite material; and, by using the case 4A as a mold, the outer core portion 32 is formed and, at the same time, the resin constituting the outer core portion 32 causes bonding between the inner core portion 31 and the outer core portion 32 to form the magnetic core 3 and, as a result, the reactor 1A can be produced. Accordingly, the number of the production steps is small. In addition, since the reactor 1A has a gapless structure, the step of bonding gap members is not necessary. In view of these respects, the reactor 1A is also excellent in terms of productivity.

Furthermore, the reactor 1A has a single coil 2 and has a horizontal configuration in which this coil 2 is housed in the case 4A such that the axial direction of the coil 2 is substantially parallel to the outer bottom surface 40o of the case 4A. Accordingly, the distance between the outer peripheral surface of the coil 2 and the case 4A is short and high heat-dissipation capability is achieved. The reactor 1A is also not bulky and has a small size.

In addition, since the outer core portion 32 is formed of the composite material, the following advantages are provided: (1) magnetic characteristics of the outer core portion 32 can be easily changed; (2) the material covering the outer periphery of the coil 2 contains the magnetic powder and hence, compared with the case where the material is formed of resin alone, the thermal conductivity is high and high heat-dissipation capability is provided; and (3) since the outer core portion 32 contains the resin component, even when the case 4A has an opening, the coil 2 and the inner core portion 31 can be protected from the external environment and mechanically protected.

### Second Embodiment

Referring to FIG. 4A and FIG. 4B, a reactor 1B in the second embodiment will be described. The basic configuration of the reactor 1B is the same as that of the above-described reactor 1A in the first embodiment. The reactor 1B includes a coil 2, a magnetic core 3, and a case 4B housing the coil 2 and the magnetic core 3. The magnetic core 3 includes an inner core portion 31 disposed so as to be inserted through the coil 2 and an outer core portion 32 covering the outer periphery of the coil 2. The outer core portion 32 is formed of a composite material containing a magnetic powder and a resin. In this composite material, the maximum bubble diameter is 300 μm or less. The reactor 1B differs from the reactor 1A with respect to the housing configuration of the coil 2. Hereinafter, this difference and its advantages will be described in detail. Detailed descriptions of the other configurations and advantages shared with the first embodiment are omitted.

The case 4B includes a bottom surface 40 having the shape of a rectangular plate and a side wall 41 that has the shape of a rectangular frame and is erected from the bottom surface 40.

The coil 2 is housed in the case 4B such that, on an inner bottom surface 40i of the case 4B, the axis of the coil 2 is perpendicular to the bottom surface 40 (outer bottom surface 40o) (hereafter, this configuration will be referred to as a vertical configuration). In addition, the inner core portion 31 inserted through the coil 2 is also housed so that the axis of the inner core portion 31 is perpendicular to the bottom surface 40; and an end surface 31e of the inner core portion 31 is in contact with the inner bottom surface 40i of the case 4B. The outer core portion 32 covers the outer peripheral surface of the coil 2 housed in the case 4B, an outer peripheral surface region of the inner core portion 31 near one end surface 31e, the other end surface 31e of the inner core portion 31, and an outer peripheral surface region of the inner core portion 31 near the other end surface 31e.

As illustrated in FIG. 4B, in the case 4B, in order to dispose the coil 2 in a middle portion of the case 4B, a positioning member (not shown) for the coil 2 is provided. The positioning member may be a member integrally formed as a part of the case 4B or may be an independent member formed from, for example, the composite material constituting the outer core portion 32. A configuration may be employed in which a positioning member (not shown; for example, a protrusion protruding from the inner bottom surface 40i) for the inner core portion 31 is also provided.

In the reactor 1B having the vertical configuration, the size of the bottom surface 40 of the case 4B can be made small and hence the installation area can be reduced, compared with the reactor 1A having the horizontal configuration. In the inner core portion 31, an end surface 31e serves as a contact surface with the case 4B and hence high stability is achieved with respect to the case 4B.

The reactor 1B having the vertical configuration can be produced in the same way as the reactor 1A having the horizontal configuration. In particular, in the case of the vertical configuration, the composite material extends upward and the path for discharging bubbles tends to be long. However, by performing the above-described specific degassing step, generation of large bubbles can be suppressed.

### First Modification

In the first and second embodiments above, configurations in which the inner core portion 31 is constituted by a compact and the outer core portion 32 alone is constituted by a composite material are described. Alternatively, another configuration may be employed in which the inner core portion is also constituted by the composite material containing a magnetic powder and a resin. That is, the configuration in which the magnetic core is substantially entirely formed of the composite material can be employed. In this case, the coil alone is housed in the case and the fluid mixture is subsequently charged into the case so as to cover the inside and outside of the coil. As a result, the configuration in which the inner core portion and the outer core portion are constituted by the same composite material can be provided. In addition, according to this configuration, the magnetic core can be produced by one step, which is excellent in terms of productivity.

Alternatively, another configuration may be employed in which the inner core portion and the outer core portion are constituted by composite materials that are different in the material or content of the magnetic powder. In this case, for example, a composite material having a columnar shape may be separately formed from a fluid mixture having a desired composition and this composite material may be used as the inner core portion.

In the production of this composite material, by employing a production method including the above-described specific degassing step, the composite material constituting the inner core portion can also be formed so as to have a maximum bubble diameter of 300 μm or less. By employing composite materials that are different in the material or content of the magnetic powder, a configuration in which the inner core portion has a higher saturation flux density than the outer core portion or a configuration in which the outer core portion has a higher saturation flux density than the inner core portion can be provided. When the content of the magnetic powder is high, a composite material having a high saturation flux density tends to be obtained; and, when the content is low, a composite material having a low relative magnetic permeability tends to be obtained.

### Second Modification

Alternatively, another configuration may be employed in which a composite material having a columnar shape is used as the inner core portion as described above and the outer core portion is constituted by a compact. In this configuration, the relative magnetic permeability of the inner core portion can be made lower than that of the outer core portion and the saturation flux density of the outer core portion can be made higher than that of the inner core portion. According to this configuration, flux leakage in the outer core portion can be reduced.

### Third Embodiment

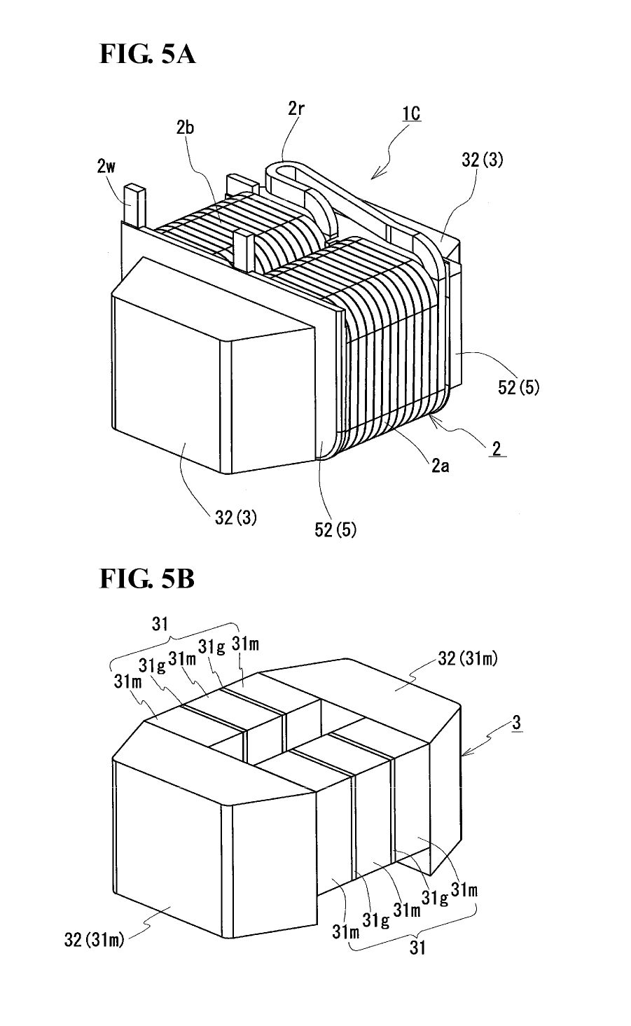

In the first and second embodiments above, configurations each including a single coil 2 are described. Alternatively, another configuration illustrated as a reactor 1C in FIG. 5A may be employed that includes a coil 2 having a pair of coil elements 2a and 2b formed by spirally winding a wire 2w which is a single continuous wire, and an annular magnetic core 3 (FIG. 5B) around which the coil elements 2a and 2b are disposed.

Typically, the coil 2 has the following configuration: the coil elements 2a and 2b constituting the pair are arranged side by side (parallel) such that the axes thereof are parallel to each other, and the coil elements 2a and 2b are coupled through a coupling portion 2r formed by folding back a portion of the wire 2w. Alternatively, another configuration may be employed in which the coil elements 2a and 2b are formed from independent wires and ends of the wires constituting these coil elements are coupled by welding such as TIG welding, press-bonding, soldering, or the like, or the ends are coupled through a coupling member that is separately prepared. The coil elements 2a and 2b have the same number of turns and the same winding direction and are formed so as to have a hollow cylindrical shape.

The magnetic core 3 has a pair of columnar inner core portions 31, 31 that are disposed inside the coil elements 2a and 2b and a pair of columnar outer core portions 32, 32 that are disposed outside the coil 2 and are exposed outside the coil 2. As illustrated in FIG. 5B, in the magnetic core 3, end surfaces of the inner core portions 31, 31 disposed so as to be separated from each other are connected through one outer core portion 32, and the other end surfaces of the inner core portions 31, 31 are connected through the other outer core portion 32. Thus, the magnetic core 3 is formed so as to have an annular shape.

In addition, the reactor 1C includes an insulator 5 for enhancing the insulation between the coil 2 and the magnetic core 3. This insulator 5 has a cylindrical part (not shown) disposed outside the columnar inner core portions 31, and a pair of frame-plate parts 52 that are in contact with the end surfaces of the coil 2 (the surfaces in which the turns are viewed as having annular shapes) and that have two through holes (not shown) through which the inner core portions 31, 31 are inserted. Materials that can be used for constituting the insulator 5 include insulating materials such as PPS resins, PTFE resins, and LCPs.

In such a configuration, for example, the magnetic core 3 may have a configuration (3-1) in which, as in the first and second embodiments, parts disposed inside the coil elements 2a and 2b, that is, the inner core portions 31, 31 are constituted by compacts or the like, and parts disposed outside the coil 2, that is, the outer core portions 32, 32 are constituted by the above-described composite material; a configuration (3-2) in which parts disposed inside the coil elements 2a and 2b, that is, the inner core portions 31, 31 are constituted by the above-described composite material, and parts disposed outside the coil 2, that is, the outer core portions 32, 32 are constituted by compacts or the like; or a configuration (3-3) in which, as in the first modification, the magnetic core 3 is entirely constituted by the above-described composite material. In each of these three configurations (3-1), (3-2), and (3-3), a configuration may be employed in which each inner core portion 31 is constituted by a magnetic material alone such as the composite material or the compact; alternatively, as illustrated in FIG. 5B, a configuration may be employed in which each inner core portion 31 is constituted by a stacked structure formed by alternately stacking a core piece 31m constituted by the above-described magnetic material and a gap member 31g constituted by a material having a lower relative magnetic permeability than the core piece 31m. As described above, the gap member 31g may be formed of a non-magnetic material or may be constituted by a mixed material containing a non-magnetic material and a magnetic powder and have a relative magnetic permeability of more than 1 (the relative magnetic permeability is preferably more than 1 and 5 or less, more preferably 1.1 or more and 1.4 or less.). A configuration may be employed in which each outer core portion 32 is constituted by, for example, the core piece 31m constituted by the above-described magnetic material. Another configuration based on the configuration (3-1) may be employed in which, as in the first embodiment, the above-described composite material is disposed so as to cover the outer periphery of the assembly of the coil 2 and the inner core portions 31, 31.

In the above-described configuration (3-1), the saturation flux density of the inner core portion 31 constituted by a compact or the like can be easily made higher than that of the outer core portion 32 constituted by the composite material containing a resin. When the inner core portion 31 has a high saturation flux density, as described above, the size of the section of the inner core portion 31 can be reduced. As a result of the reduction of the size of the inner core portion 31 in the configuration (3-1), as described above, a small reactor can be constituted. In addition, as a result of the reduction of the size of the inner core portion 31 in the configuration (3-1), the length of the wire 2w can be decreased to thereby reduce the weight of the reactor.

In the above-described configuration (3-2), in contrast to the configuration (3-1), the saturation flux density of the outer core portion 32 can be easily made higher than that of the inner core portion 31 and hence flux leakage from the outer core portion 32 to the outside can be reduced. Accordingly, in the configuration (3-2), loss due to flux leakage can be reduced and the magnetic flux generated by the coil 2 can be sufficiently used.

In the above-described configuration (3-3), when the whole magnetic core is uniformly constituted by the material, not only in the case where the magnetic core is produced as a single molded product but also in the case where the magnetic core is constituted by a plurality of core pieces, the magnetic core can be easily produced with high productivity. In the configuration (3-3), in the case where the material or content of the magnetic powder is adjusted to provide a composite material having a low relative magnetic permeability (for example, the relative magnetic permeability is 10 or more and 20 or less), a gapless structure can be provided. Accordingly, flux leakage from gap portions is not caused and an increase in the size of the reactor due to the presence of gaps can also be suppressed. Alternatively, in the configuration (3-3), by using different core pieces in terms of the material or content of the magnetic powder, the magnetic core can also have different magnetic characteristics depending on portions, as in the configuration (3-1) and the configuration (3-2). In addition, in the configuration (3-3), by employing a configuration in which the inside and outside of the coil is covered by the composite material, the coil can be protected by the resin component of the composite material.

As in the first embodiment, the inner core portion 31 of the reactor 1C in the third embodiment can also be obtained as an integrated product through compacting with a mold having a desired shape or can be obtained as an integrated product by fixing a plurality of core pieces with an adhesive, an adhesive tape, or the like. Bonding between the inner core portion 31 and the outer core portion 32 can be achieved by the resin in the composite material constituting the inner core portion 31 or the outer core portion 32. In this case, bonding between the inner core portion 31 and the outer core portion 32 is achieved without any adhesive. By using the resin in the composite material to achieve bonding, the necessity of an adhesive can be eliminated. Accordingly, the number of steps can be decreased so that the reactor 1C can be produced with high productivity. Alternatively, as in the first embodiment, bonding between the inner core portion 31 and the outer core portion 32 can be achieved by an adhesive; or, in another configuration in which gap members are provided, bonding between the inner core portion 31, the outer core portion 32, and the gap members can be achieved with an adhesive. The bonding may be performed by a plurality of bonding steps. When the amount of the adhesive is sufficiently small, it is considered that the adhesive does not substantially function as gap members.

### Test Example 1

The relationships between the size (here, diameter) of bubbles present in a composite material, loss (here, iron loss), and inductance were examined by simulation.

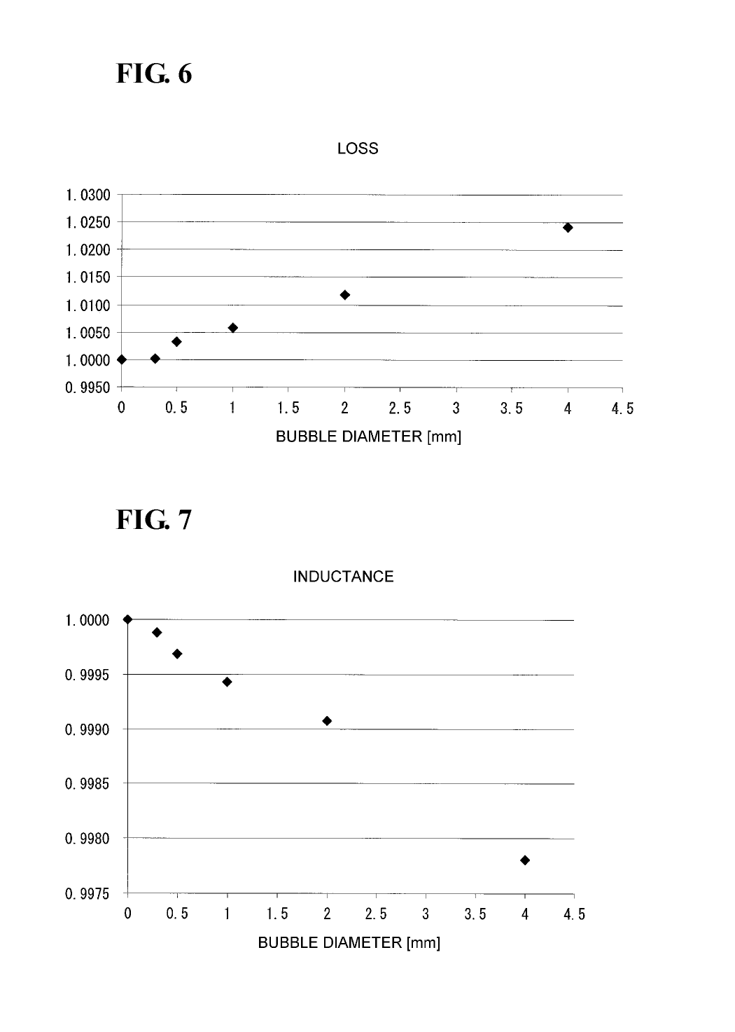

Here, the reactor in the first embodiment (a coil, a magnetic core (an inner core portion and an outer core portion), and a case housing the assembly of the magnetic core and the coil) was modeled as a test sample. A case was considered where a single bubble (modeled bubble) having a diameter described in Table I was present in the composite material constituting the outer core portion; and changes in iron loss and changes in inductance due to changes in the diameter were calculated by three-dimensional magnetic field analysis. This analysis was performed with a commercially available computer aided engineering (CAE) software. The results are described in Table I, FIG. 6 (loss), and FIG. 7 (inductance). The iron-loss value and the inductance value of Sample No. 1 in an ideal state of no bubbles were defined as references (1). Regarding each of Sample No. 2 to 6, the degree of an increase in the iron loss with respect to the iron loss of Sample No. 1 in the ideal state and the degree of a decrease in the inductance with respect to the inductance of Sample No. 1 in the ideal state were determined. Regarding inductance, the value of a current to be supplied was 170 A.

TABLE I

| | Bubble | | Inductance |
|---|---|---|---|
| Sample | diameter | Loss value of | value of |
| No. | [mm] | sample/reference | sample/reference |
| 1 | 0 | Reference: 1.0000 | Reference: 1.0000 |
| 2 | 0.3 | 1.0001 | 0.9999 |
| 3 | 0.5 | 1.0032 | 0.9997 |
| 4 | 1 | 1.0058 | 0.9994 |
| 5 | 2 | 1.0118 | 0.9991 |
| 6 | 4 | 1.0242 | 0.9978 |

Table I, FIG. 6, and FIG. 7 indicate that, when the maximum bubble diameter is 300 μm (0.3 mm) or less, the increase in the loss is very small. Specifically, when the maximum bubble diameter is 300 μm (0.3 mm) or less, with respect to the case where the maximum bubble diameter is 0 mm, that is, the no-bubble case, the increase ratio of the loss can be suppressed to 0.01% or less and the decrease ratio of the inductance can also be suppressed to 0.01% or less. Thus, when the maximum bubble diameter is 300 μm (0.3 mm) or less, the increase in the loss and the decrease in the inductance are very small. Accordingly, by using a composite material having a maximum bubble diameter of 300 μm or less as a material of a magnetic core of a reactor, a reactor in which the loss is low and magnetic characteristics are less likely to be decreased can be obtained. In addition, based on the results in Table I, FIG. 6, and FIG. 7, when the maximum bubble diameter is 200 μm or less, further 100 μm or less, the increase in the loss and the decrease in the inductance can be substantially made zero.

### Reference Test Example 2

The relationships between the content (% by volume) of bubbles present in a composite material, loss (here, iron loss), and inductance were examined by simulation.

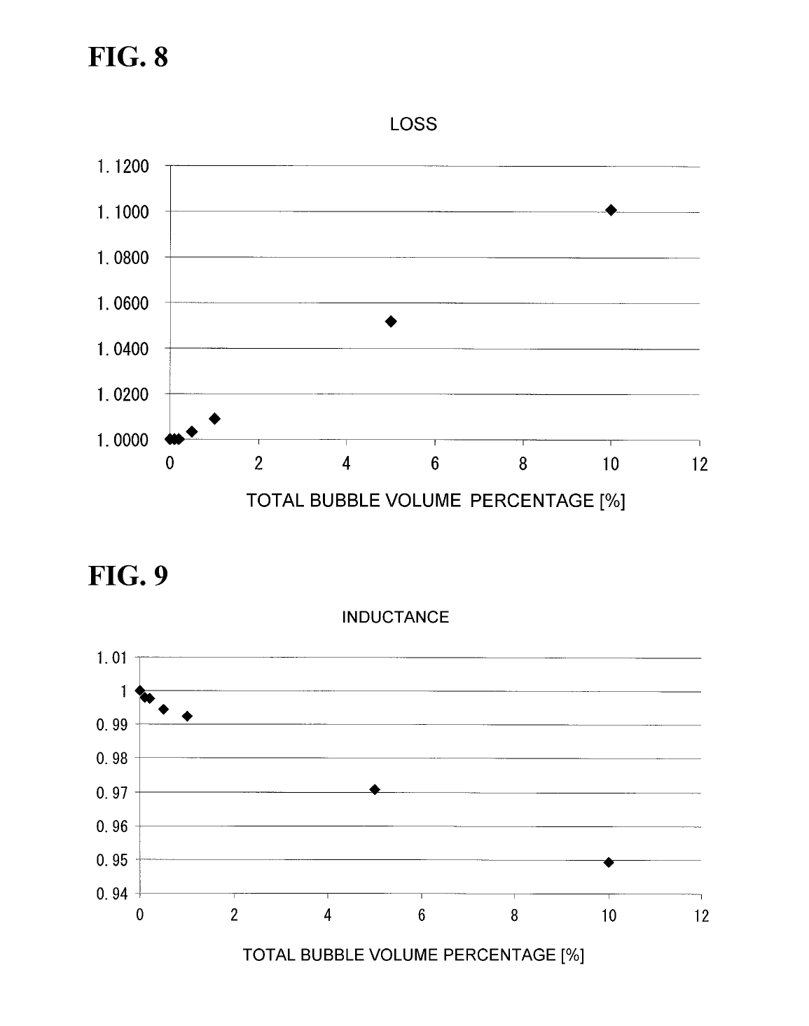

Here, as in Test example 1, the reactor in the first embodiment was modeled as a test sample. Regarding a case where a bubble (modeled bubble) having a diameter of 300 μm is present in the composite material constituting the outer core portion, changes in iron loss and changes in inductance due to changes in the content of bubbles were calculated, as in Test example 1, by three-dimensional magnetic field analysis with the commercially available software. The results are described in Table II, FIG. 8 (loss), and FIG. 9 (inductance). As in Test example 1, the iron-loss value and the inductance value of Sample No. 11 in an ideal state of no bubbles were defined as references (1). Regarding each of Sample No. 12 to 17, the degree of an increase in the iron loss with respect to the iron loss of Sample No. 11 in the ideal state and the degree of a decrease in the inductance with respect to the inductance of Sample No. 11 in the ideal state were determined. Regarding the content (% by volume) of bubbles, assuming that one or more bubbles having a diameter of 300 μm were present in the composite material, the number of the bubbles was changed to thereby change the content of bubbles. Regarding inductance, the value of a current to be supplied was 170 A.

TABLE II

| | Bubble | | Inductance |
|---|---|---|---|
| Sample | content | Loss value of | value of |
| No. | [vol %] | sample/reference | sample/reference |
| 11 | 0 | Reference: 1.0000 | Reference: 1.0000 |
| 12 | 0.1 | 1.0001 | 0.9979 |
| 13 | 0.2 | 1.0001 | 0.9977 |
| 14 | 0.5 | 1.0032 | 0.9946 |
| 15 | 1 | 1.0091 | 0.9925 |
| 16 | 5 | 1.0517 | 0.9709 |
| 17 | 10 | 1.1011 | 0.9492 |

Table II, FIG. 8, and FIG. 9 indicate that, by using a composite material having a maximum bubble diameter of 300 μm or less and a bubble content of 10% by volume or less as a material of a magnetic core of a reactor, a reactor in which the loss is low and magnetic characteristics are less likely to be decreased can be obtained. Depending on allowable ranges of the degree of a decrease in the inductance and the degree of an increase in the loss, by using a composite material having a bubble content of 5% by volume or less, further 1% by volume or less, as a material of a magnetic core of a reactor, a reactor in which the loss is lower and magnetic characteristics are even less likely to be decreased can be obtained. In order to further decrease the loss, a composite material having a bubble content of less than 0.5% by volume can be used as a material of a magnetic core of a reactor.

Note that the content (% by volume) of bubbles present in a composite material used for a magnetic core of a reactor or the like can be measured by, for example, in the following manner. A sample piece having an appropriate size is first cut from the composite material. The density Dₐₗₗ of the whole sample piece is measured. Subsequently, in this sample piece, a portion having no bubbles is cut and the density Dₙₒ of this portion is measured. From these values, the content (% by volume) of bubbles can be calculated by {(density Dₙₒ of portion having no bubbles−density Dₐₙ of the whole sample piece)/density Dₙₒ of portion having no bubbles}×100(%). Density ρ can be determined from the weight in the air and the weight in water in the following manner. When ρ_{w} represents the density of water, ρₐᵢᵣ represents the density of the air, W_{w} represents the weight in water, and Wₐᵢᵣ represents the weight in the air, on the basis of Archimedes' principle, the following formula is presented.

ρ=(ρ_{w}×Wₐᵢᵣ−ρₐᵢᵣ×W_{w})/(Wₐᵢᵣ−W_{w})

Approximately, there is a relationship of ρ_{w}>>ρₐᵢᵣ and hence the formula can be converted into ρ≈ρ_{w}×Wₐᵢᵣ/(Wₐᵢᵣ−W_{w}).

### Fourth Embodiment

The reactors in the first to third embodiments and first and second modifications above can be used as, for example, components of converters mounted on vehicles or the like or components of power conversion devices including the converters.

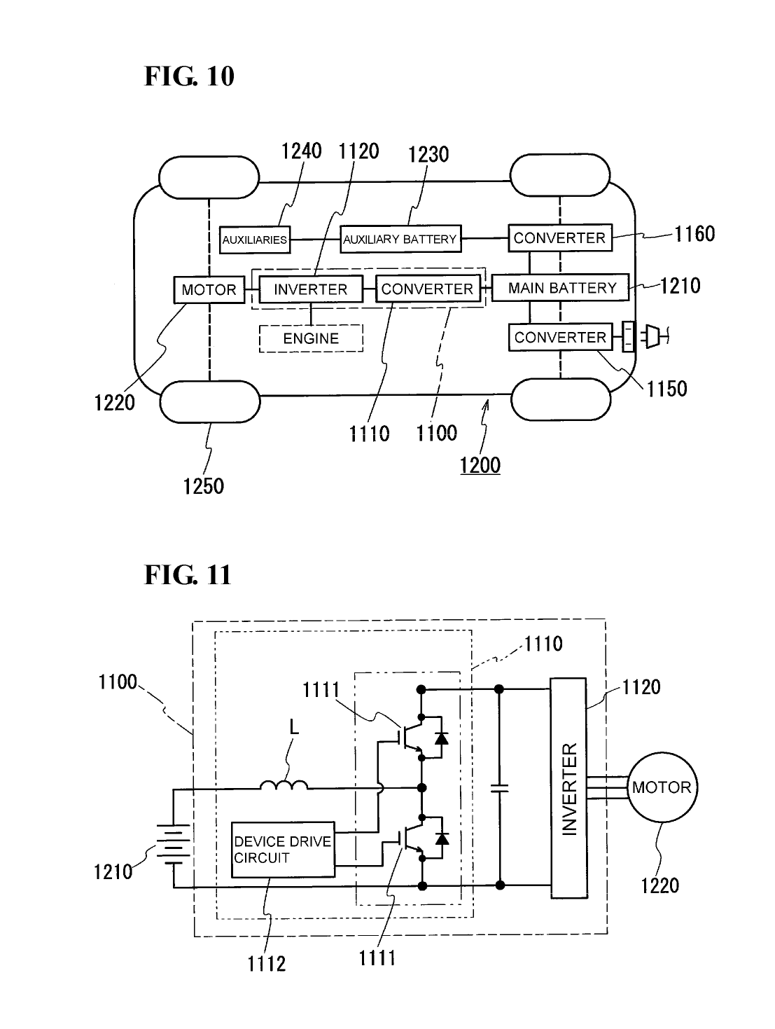

For example, as illustrated in FIG. 10, a vehicle 1200 such as a hybrid electric vehicle or an electric vehicle includes a main battery 1210, a power conversion device 1100 connected to the main battery 1210, and a motor (load) 1220 that is driven by supplied power from the main battery 1210 and used for driving. Typically, the motor 1220 is a three-phase alternating-current motor. The motor 1220 drives wheels 1250 during driving and functions as a generator during regeneration. In the case of a hybrid electric vehicle, the vehicle 1200 includes the motor 1220 and an engine. Note that, FIG. 10 illustrates an inlet as the charging receptacle of the vehicle 1200; however, a configuration in which a plug is provided may be employed.

The power conversion device 1100 includes a converter 1110 connected to the main battery 1210 and an inverter 1120 that is connected to the converter 1110 and performs interconversion between direct current and alternating current. During driving of the vehicle 1200, the converter 1110 described in this example increases the direct-current voltage (input voltage, about 200 V to about 300 V) from the main battery 1210 to about 400 V to about 700 V and supplies the current to the inverter 1120. During regeneration, the converter 1110 decreases the direct-current voltage (input voltage) output from the motor 1220 through the inverter 1120, to a direct-current voltage suitable for the main battery 1210 to allow charging of the main battery 1210. During driving of the vehicle 1200, the inverter 1120 converts a direct current at a voltage having been increased by the converter 1110, to a predetermined alternating current and supplies this alternating current to the motor 1220. During regeneration, the inverter 1120 converts an alternating current output from the motor 1220, to a direct current and outputs this direct current to the converter 1110.

As illustrated in FIG. 11, the converter 1110 includes a plurality of switching elements 1111, a drive circuit 1112 that controls the operation of the switching elements 1111, and a reactor L. The converter 1110 repeatedly performs switching ON/OFF (switching operation) to convert the input voltage (here, increase or decrease the voltage). The switching elements 1111 are power devices such as a field-effect transistor (FET) or an insulated gate bipolar transistor (IGBT). The reactor L utilizes the coil characteristic of suppressing changes in a current passing through a circuit and has a function of, in response to an increase or decrease in the current due to the switching operation, making this change gentler. This reactor L is selected from the reactors 1A and the like in the first to third embodiments and the first and second modifications. The power conversion device 1100 and the converter 1110 include the reactor 1A and the like that have high flux density and exhibit a low loss and, as a result, exhibit a low loss.

Note that the vehicle 1200 includes, in addition to the converter 1110, a converter 1150 that is used for a power supply device and connected to the main battery 1210; and a converter 1160 that is used for an auxiliary power source, that is connected to an auxiliary battery 1230 serving as a power source for auxiliaries 1240 and to the main battery 1210, and that converts a high voltage of the main battery 1210 to a low voltage. Typically, the converter 1110 performs DC-DC conversion, whereas the converter 1150 for a power supply device and the converter 1160 for an auxiliary power source perform AC-DC conversion. The converter 1150 for a power supply device may perform DC-DC conversion is some cases. The converter 1150 for a power supply device and the converter 1160 for an auxiliary power source may include, as reactors, reactors that have configurations similar to those of the reactors 1A and the like in the first to third embodiments and the first and second modifications and that are appropriately changed from the reactors 1A and the like in terms of size, shape, or the like. In addition, among converters that convert input power, converters that only increase the voltage and converters that only decrease the voltage may include the reactors 1A and the like in the first to third embodiments and the first and second modifications.

Note that the present invention is not limited to the above-described embodiments. Changes can be appropriately made without departing from the spirit and scope of the present invention. For example, material properties of the composite material (for example, the composition and content of the magnetic powder and the type of the resin), the size of the magnetic powder, material properties of the magnetic core, or the shape of end surfaces of the coil can be changed.

### INDUSTRIAL APPLICABILITY

A reactor according to the present invention can be used as a component for DC-DC converters mounted on vehicles such as hybrid electric vehicles, plug-in hybrid electric vehicles, electric vehicles, and fuel cell vehicles, converters for air-conditioning equipment, power conversion devices, and the like. A reactor core according to the present invention can be suitably used as a component of the above-described reactor according to the present invention. A composite material according to the present invention can be suitably used as a material for the above-described reactor according to the present invention or another magnetic component.

### REFERENCE SIGNS LIST

1A, 1B, 1C reactor
2 coil; 2w wire; 2a, 2b coil element; 2r coupling portion
3 magnetic core; 31 inner core portion; 31e end surface; 31m core piece; 31g gap member
32 outer core portion
4A, 4B case; 40 bottom surface; 40i inner bottom surface; 40o outer bottom surface; 41 side wall
45 mounting part; 45h bolt hole
5 insulator; 52 frame-plate part
1100 power conversion device; 1110 converter; 1111 switching element
1112 drive circuit; L reactor; 1120 inverter
1150 converter for power supply device; 1160 converter for auxiliary power source
1200 vehicle; 1210 main battery; 1220 motor; 1230 auxiliary battery
1240 auxiliaries; 1250 wheel

1. A reactor comprising a coil and a magnetic core,
wherein at least a portion of the magnetic core is formed of a composite material containing a magnetic powder and a resin, and
a maximum diameter of bubbles in a section of the composite material is 300 μm or less.

2. The reactor according to claim 1, wherein a total area percentage of the bubbles in the section of the composite material is 1% or less.

3. The reactor according to claim 2, wherein a total area percentage of the bubbles in the section of the composite material is 0.2% or less.

4. The reactor according to claim 1, wherein a volume percentage of the magnetic powder in the composite material is 30% by volume or more and 70% by volume or less.

5. The reactor according to claim 1, wherein at least a portion of a part of the magnetic core, the part being disposed inside the coil that has a cylindrical shape and is formed by winding a wire, is formed of the composite material.

6. The reactor according to claim 1, wherein at least a portion of a part of the magnetic core, the part being disposed outside the coil that has a cylindrical shape and is formed by winding a wire, is formed of the composite material.

7. The reactor according to claim 1, wherein the magnetic core is substantially entirely formed of the composite material.

8. The reactor according to claim 1, further comprising a case that houses an assembly of the coil and the magnetic core,
wherein the coil is housed in the case such that an axis of the coil is substantially parallel to a bottom surface of the case; and
a part of the magnetic core, the part covering at least a portion of an outer periphery of the coil, is formed of the composite material.

9. A composite material comprising a magnetic powder and a resin,
wherein a maximum diameter of bubbles in a section of the composite material is 300 μm or less.

10. The composite material according to claim 9, wherein a total area percentage of the bubbles in the section of the composite material is 1% or less.

11. The composite material according to claim 10, wherein a total area percentage of the bubbles in the section of the composite material is 0.2% or less.

12. A reactor core comprising the composite material according to claim 9.

13. A converter comprising a switching element, a drive circuit that controls operation of the switching element, and a reactor that smoothes switching operation, the switching element being configured to operate to convert an input voltage,
wherein the reactor is the reactor according to claim 1.

14. A power conversion device comprising a converter that converts an input voltage; and an inverter that is connected to the converter and performs interconversion between direct current and alternating current, the inverter being configured to supply a converted power for driving a load,
wherein the converter is the converter according to claim 13.
